(19) United States
(12) Patent Application Publication
(10) Pub. No.: US 2010/0318598 A1
(43) Pub. Date: Dec. 16, 2010

(54) METHOD FOR REMOTELY CONTROLLING TERMINAL DEVICE

(75) Inventors: Chan Phill YUN, Seoul (KR); Jong Sung Lee, Seoul (KR); Eun Young Park, Seoul (KR); Jin Ho Sohn, Seoul (KR); Sun Ryang Kim, Seoul (KR)

Correspondence Address: BIRCH STEWART KOLASCH & BIRCH, PO BOX 747, FALLS CHURCH, VA, 22040-0747, US

(73) Assignee: LG ELECTRONICS INC., Seoul (KR)

(21) Appl. No.: 12/793,636

(22) Filed: Jun. 3, 2010

(30) Foreign Application Priority Data
Jun. 15, 2009 (KR) 10-2009-0053053

(51) Int. Cl. G06F 15/16; G06F 9/54

(52) U.S. Cl. 709/203; 709/219; 719/328

(57) ABSTRACT

Provided are a remotely controllable communication terminal and a method for processing a request thereof. The remotely controllable communication terminal comprises a user input unit, a storage unit, a communication unit, and a control unit. The user input unit receives a user input. The storage unit stores software called by Application Programming Interfaces (APIs) corresponding to a plurality of functions, respectively. The communication unit sends a file comprising a list of the APIs to a client terminal, receives one of the APIs from the client terminal, and then sends an execution result to the client terminal. The control unit receives the API and performing a function corresponding to the API.

### CROSS-REFERENCE TO RELATED APPLICATIONS

The present application claims priority under 35 U.S.C. 119 and 35 U.S.C. 365 to Korean Patent Application No. 10-2009-0053053 filed on Jun. 15, 2009, which is hereby incorporated by reference in its entirety.

### BACKGROUND

The present disclosure relates to a method for controlling a communication terminal remotely, and more particularly, to a method for controlling a communication terminal by allowing the communication terminal having a private IP in a common network to operate as a server and connecting to the communication terminal by remote. In order to remotely control the communication terminal, a client terminal may connect to communication terminal through a relay server having a certified IP address and a gateway server converting a private IP into a certified IP.

Generally, since mobile terminals such as cellular phones and communication terminals such as desktop computers and laptop computers connectable to Internet have private IPs, the terminals can access external servers, but external terminals can not access the communication terminals.

Recently, as the distribution of personal communication terminals increases rapidly, various functions such as photographing, GPS, navigation are provided in communication terminals that can store multimedia data such as photographs, documents, and videos. Accordingly, demands for remotely connecting mobile communication terminals to access stored multimedia files or for accessing communication terminals to use various functions provided in the communication terminals are progressively increasing.

However, there are many limitations in connecting to the communication terminals remotely. Accordingly, a method for overcoming these limitations is required.

### SUMMARY OF THE INVENTION

Embodiments provide a method for operating a communication terminal pertaining to a private network and not having a certified IP as a server.

Embodiments also provide a method for controlling a communication terminal through the same interface as the communication terminal by transmitting screen information of the communication terminal that is operated as a server to a client terminal and using the screen information in the client terminal.

Embodiments also provide a method for remotely controlling a communication terminal by configuring various functions of a communication terminal with Application Programming Interface (API).

Embodiments also provide a method for remotely controlling a communication terminal by disposing a shared memory which a client terminal can read and write data from/to in the communication terminal.

Embodiments of the invention provide a method and system for controlling communication between one client terminal and another terminal functioning as a server, which address the limitations and disadvantages associated with the related art.

In one embodiment, a remotely controllable communication terminal comprises: a user input unit receiving a user input; a storage unit storing software called by Application Programming Interfaces (APIs) corresponding to a plurality of functions, respectively; a communication unit sending a file comprising a list of the APIs to a client terminal, receiving one of the APIs from the client terminal, and then sending an execution result to the client terminal; and a control unit receiving the API and performing a function corresponding to the API.

In another embodiment, a method for processing a request of a remotely controllable communication terminal comprises: sending a file comprising a list of APIs to a client terminal; receiving one of the APIs from the client terminal; converting a received execution code into an executable API; performing a function corresponding to the API; and sending a result of the performed function to the client terminal.

In further another embodiment, a communication terminal operating as a server comprises: a user input unit receiving a user input; a storage unit storing software necessary for an operation; a communication unit receiving a request from a client terminal, and sending an execution result of the request to the client terminal; a shared storage unit storing the request received from the client terminal; and a control unit monitoring the shared storage unit and, if the request is recorded, read the recorded request to execute.

In still further another embodiment, a method for processing a request by a communication terminal operating as a server comprises: monitoring a shared storage unit accessible by a client terminal; receiving a request from the client terminal; recording the received request in the shared storage unit; reading the recorded request from the shared storage unit; executing the read request; and sending a result of the execution of the request to the client terminal.

According to another embodiment, the invention provides a remotely controllable communication terminal comprising: a user input unit configured to receive a user input; a storage unit configured to store software to be called by APIs corresponding respectively to a plurality of functions; a communication unit; and a control unit cooperating with the user input unit, the storage unit and the communication unit, and configured to: send, through the communication unit, a file including a list of the APIs to a client terminal, receive a selection of an API from the list of the APIs from the client terminal, execute a function corresponding to the selected API using the stored software, and send a result of the execution of the function to the client terminal.

According to another embodiment, the invention provides a method for controlling a remotely controllable communication terminal, the method comprising: sending, by the communication terminal to a client terminal, a file including a list of execution codes for respectively executing APIs; receiving, by the communication terminal, a selection of an executed code from the list from the client terminal; converting, by the communication terminal, the received selected execution code into an executable API; performing, by the communication terminal, a function corresponding to the executable API; and sending, by the communication terminal, a result of the performed function to the client terminal.

According to another embodiment, the invention provides a communication terminal operating as a server, comprising: a user input unit configured to receive a user input; a storage unit configured to store software for executing operations of the communication terminal; a shared storage unit shared with a client terminal; and a control unit cooperating with the user input unit, the storage unit, and the shared storage unit, and configured to: receive a request from the client terminal, record the received request in the shared storage unit, monitor the shared storage unit and determine whether the received request is recorded in the shared storage unit, read the request recorded in the shared storage unit based on the determining results, execute the read request, and send a result of the execution of the request to the client terminal.

According to another embodiment, the invention provides a method for controlling a communication terminal operating as a server, the communication terminal including a shared storage unit shared with a client terminal, the method comprising: receiving, by the communication terminal, a request from the client terminal; recording the received request in the shared storage unit of the communication terminal; monitoring the shared storage unit and determining whether the received request is recorded in the shared storage unit; reading the request recorded in the shared storage unit based on the determining results; executing, by the communication terminal, the read request; and sending, by the communication terminal, a result of the execution of the request to the client terminal.

The details of one or more embodiments are set forth in the accompanying drawings and the description below. Other features will be apparent from the description and drawings, and from the claims.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view illustrating a network configuration according to an embodiment of the invention;

FIG. 2 is a view illustrating a configuration of a communication terminal 20 according to an embodiment of the invention;

FIG. 3 is a view illustrating a method for a communication terminal 20 to connect to a relay server 40 through a gateway server 30 according to an embodiment of the invention;

FIG. 4 is a view illustrating a method for a client terminal 50 to connect to a communication terminal 20 through a relay server 40 according to an embodiment of the invention;

FIG. 5 is a flowchart illustrating a method for a communication terminal 20 pertaining to a private network to operate as a server according to an embodiment of the invention;

FIG. 6 is a flowchart illustrating a method for a communication terminal 20 pertaining to a private network to operate as a server in a relay server 40 according to an embodiment of the invention;

FIG. 7 is a flowchart illustrating a method for a communication terminal 20 pertaining to a private network to operate as a server in a client terminal 50 according to an embodiment of the invention;

FIG. 8 is a view illustrating a mobile phone of a mobile terminal type according to an embodiment of the invention;

FIG. 9 is a view illustrating a method for a client terminal 50 to remotely control a communication terminal 20 by connecting to the communication terminal 20 according to another embodiment of the invention;

FIGS. 10 to 16 are views illustrating compression and decompression processes of screen information performed in a communication and a gateway server according to an embodiment of the invention;

FIG. 17 is a flowchart illustrating a process performed by a communication terminal 20 during the process of transmitting screen information from the communication terminal to a client terminal 50 according to an embodiment of the invention;

FIG. 18 is a flowchart illustrating a process performed by a gateway server 30 during a process of transmitting screen information from a communication terminal 20 to a client terminal 50 according to an embodiment of the invention;

FIG. 19 is a flowchart illustrating a process performed by a client terminal 50 during a process of transmitting screen information from a communication terminal 20 to the client terminal 50 according to an embodiment of the invention;

FIG. 20 is a view illustrating a method for remotely controlling a communication terminal 20 through a client terminal 50 by a user according to an embodiment of the invention;

FIG. 21 is a view illustrating a menu screen displayed on a client terminal 50 to perform remote control according to an embodiment of the invention;

FIG. 22 is a view illustrating a method for a client terminal 50 to remotely control a communication terminal 20 using an HTML file according to an embodiment of the invention;

FIG. 23 is a view illustrating a relation between an execution code transmitted from a client terminal 50 and an API command performed by a communication terminal 20 according to an embodiment of the invention;

FIG. 24 is a flowchart illustrating a process performed in a communication terminal 20 during a process of controlling a communication terminal 20 in a client terminal 50 according to an embodiment of the invention;

FIG. 25 is a flowchart illustrating a process performed in a relay server 40 during a process of controlling a communication terminal 20 in a client terminal 50 according to an embodiment of the invention;

FIG. 26 is a flowchart illustrating a process performed in a client terminal 50 during a process of remotely controlling a communication terminal 20 through a client terminal 50 according to an embodiment of the invention;

FIG. 27 is a view illustrating a configuration of a communication terminal 20-1 having a shared storage unit 24 shared with a client terminal 50 according to an embodiment of the invention;

FIG. 28 is a view illustrating a method for remotely controlling a communication terminal 20-1 by a client terminal 50 using a shared storage unit 24 of the communication terminal 20-1 according to an embodiment of the invention;

FIG. 29 is a flowchart illustrating a method performed by a communication terminal 20 during a process of remotely controlling a communication terminal 20 by client terminal 50 according to an embodiment of the invention; and

FIG. 30 is a flowchart illustrating a method performed by a client terminal 50 during a process of remotely controlling a communication terminal 20 by the client terminal 50 according to an embodiment of the invention.

### DETAILED DESCRIPTION OF THE EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

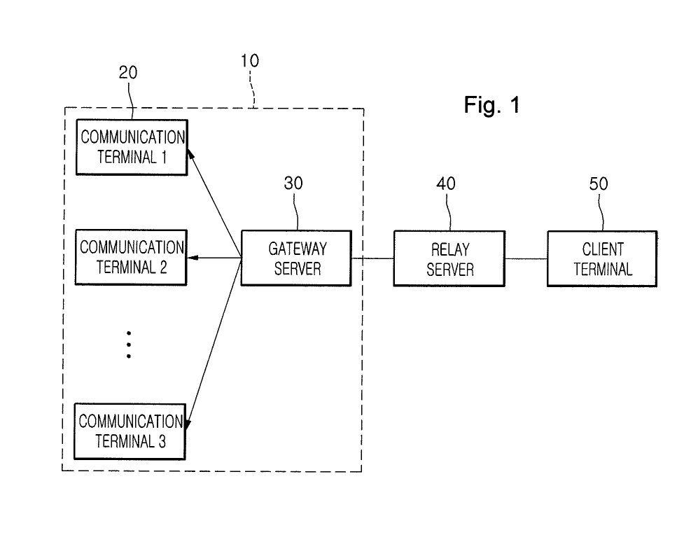

FIG. 1 is a view illustrating a network configuration according to an embodiment. Referring to FIG. 1, a terminal device 20 may pertain to a private network 10, and may perform communication with external devices through gateway server 30. That is, the terminal device 20 may not have a common IP address but have only a private IP address in a private network.

The terminal device 20 may be a device that is used to allow a user to connect to Internet. For example, the terminal device 20 may include communication terminals such as desktop computers, laptop computers, and mobile phones.

According to a related-art, since the terminal device 20 have a private IP address, the terminal 20 may not be accessed by an external device of the private network 10, but may be directly accessed according to an embodiment.

The gateway server 30 may be a communication device capable of performing a Network Address Translator (NAT) function. For example, an NAT function may be set in a router to be used, and a proxy server may also perform the above function.

The gateway server 30 may be a server of an Internet Server Provider (ISP) when the terminal device 20 is a general PC or a laptop computer. The gateway server 30 may be a server of a telecommunication service provider when the terminal 20 is a mobile terminal such as mobile phones using 2G or 3G network.

A relay server 40 may relay communication between a client terminal 50 and a communication terminal 20. A user of the client terminal 50 may connect to the relay server 40 using a unique certified IP address of the relay server 40 and a unique parameter of the communication terminal 20. The relay server 40 may connect the communication terminal 20 to the client terminal 50 using the unique parameter of the communication terminal 10.

According to an embodiment, after the communication terminal 20 may be connected to the client terminal 50, the relay server 40 may forward data between the communication terminal 20 and the client terminal 50. That is, the relay server 40 may serve only to forward data transferred between the communication terminal 20 and the client terminal 50, i.e., requests, or processing results corresponding thereto or data. The data forwarded by the relay server 40 may be temporarily stored in the relay server 40, and data processing may not be performed.

The client terminal 50 may be a terminal connectable to Internet. For example, the client terminal 50 may include mobile phones, desktop computers, and laptop computers. A user of the client terminal 50 may know beforehand the unique certified IP of the relay server 40 and the unique parameter of the communication terminal 20 to connect. The user may connect to the relay server 40 using the certified IP, and connect to the communication terminal 20 using the unique parameter.

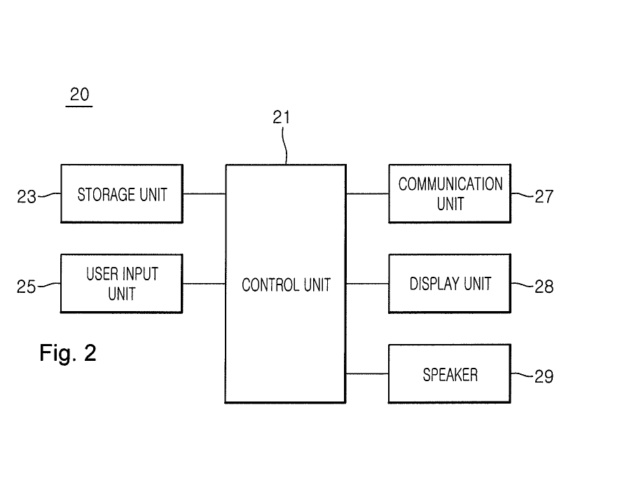

FIG. 2 is a view illustrating a configuration of a communication terminal 20 according to an embodiment. The communication terminal 20 may be connected to a client terminal through a gateway server converting a private IP address into a certified IP address and a relay server having a common IP address and forwarding data. As shown in FIG. 2, the communication terminal 20 may include an input unit 25, a storage unit 23, a communication unit 27, and a control unit 21. The input unit 25 may receive a user input. The storage unit 23 may store software necessary to process a request from the client terminal 50. The communication unit 27 may receive a certain request from the client terminal 50 via the relay server 40, and transmit data through the relay server in response to the request. The control unit 21 may receive and process the request from the client terminal 50, and control the communication unit 27 according to software stored in the storage unit 23.

According to an embodiment, the communication terminal 20 may further include a display unit 28 displaying a processing state and a control menu for a user or a speaker 29 outputting sound.

Except the software stored in the storage unit 23 for a server operation, the client terminal 50 may have the same configuration as shown in FIG. 2. If the software for the server operation is stored in the storage unit 23, the client terminal 50 may also operate as a server.

According to an embodiment, since the communication terminal 20 pertains to a private network, the communication terminal 20 has to be first connected to the relay server 40 to connect to the client terminal 50. In a state of connection to the relay server 40, if the client terminal 50 connects to the relay server 40 to deliver the unique parameter of the communication terminal 20, the relay server 40 may connect the communication terminal 20 to the client terminal 50. The communication terminal 20 may connect to the relay server 40 through the gateway server 30 that performs a function of converting a private IP address into a certified IP address, i.e., a NAT function.

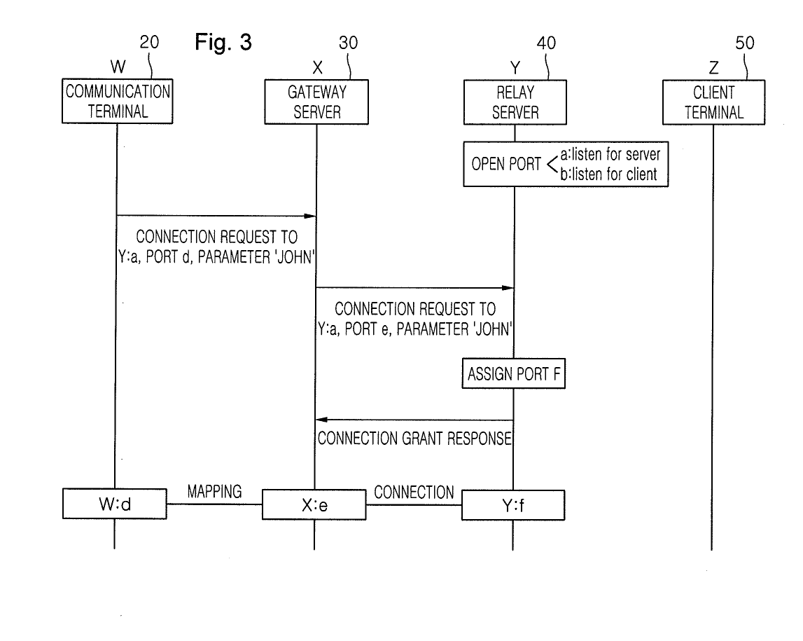

FIG. 3 is a view illustrating a method for a communication terminal 20 to connect to a relay server 40 through a gateway server 30 according to an embodiment. For convenience of explanation, the IP addresses of the communication terminal 20, the gateway server 30, the relay server 40, and the client terminal 50 are assumed to be W, X, Y, and Z, respectively. The IP address of the communication terminal 20 may be a private IP address.

The relay server 40 may have a limited number of ports, and may process simultaneous connections as many as the number of the ports. For example, the number of the ports of the relay server 40 may be about 2̂16-1, 65535. The relay server 40 may assign a port a (listen for server) and a port b (listen for client), and may be in a standby state.

The communication terminal 20 may transmit a connection request of the relay server 40 to the gateway server 30. That is, the communication terminal 20 may transmit a request for connection to Y:a to the gateway server 30. In this case, it is assumed that d is assigned to its own port. The communication terminal 20 may request connection between it own port W:d and the port Y:a of the relay server 40. Here, the communication terminal 20 may also transmit a unique parameter, for example, “John”, which allows the communication terminal 20 to be identified. The unique parameter may be information known beforehand for the client terminal 50 to connect to the communication terminal 20. The unique parameter may be informed to the client terminal 50 by off-line or other modes.

The gateway server 30 may receive the connection request of the communication terminal 20 to perform a mapping for its own port X: e, and may deliver the connection request to the relay server 40 together with the parameter “John”.

The relay server 40 may assign a port Y:f and send a response of granting the connection request from the communication terminal 20.

Consequently, as shown in FIG. 3, the ports W:d, W:e, and Y:f of the communication terminal 20, the gateway server 30, and the relay server 40 are connected to one another. If connected, data communication may be enabled among the ports W:d, W:e, and Y:f.

Through the above process, although the communication terminal 20 belongs to a private network, the external client terminal 50 may enter a state capable of sending a request by connecting like a typical server.

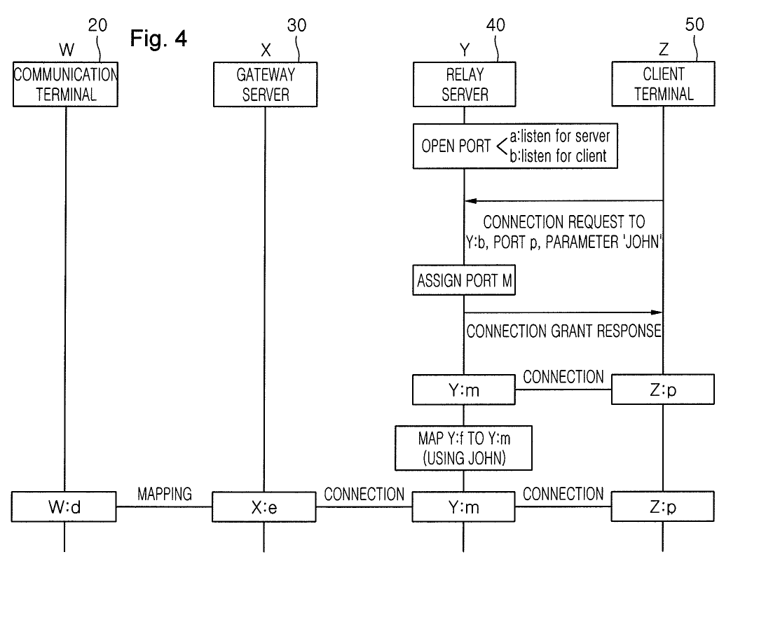

Hereinafter, a method for the client terminal 50 to connect to the communication terminal 20 through the relay server 40 will be described in detail with reference to FIG. 4.

The client terminal 50 attempts to connect to Y:b of the relay server 40 using the parameter “John”. It is assumed that p is assigned to its own port. That is, it is assumed that connection of Y:b of the relay server 40 to a port Z:p of the client terminal 50 is requested. As described above, the port b may be a port that the relay server 40 has opened for connection of the client terminal.

The relay server 40 may assign its own port Y:m together with a response of granting a connection request of the client terminal 50. That is, ports Y:m and Z:p are connected to each other.

The relay server 40 may recognize and map the connection W:d-X:e-Y:f with the communication terminal 20 and the connection Y:m-Z:p with the client terminal 50 using the parameter “John”. That is, the mapping of the ports Y:f and Y:m of the relay server 40 may be performed.

Consequently, as shown in FIG. 4, the ports W:d-X:e-Y:m-Z:p of the communication terminal 20 may be connected to another through the relay server 40.

After the connection is established, the client terminal 50 may transmit a request by connecting to the communication terminal 20 through the relay server 40 and the gateway server 30, and communication terminal 20 may operate as a server with respect to the client terminal 50. When the communication terminal 20 operates as a server, the relay server intervened between the communication terminal 20 and the client server 50 may only forward data through the connected ports

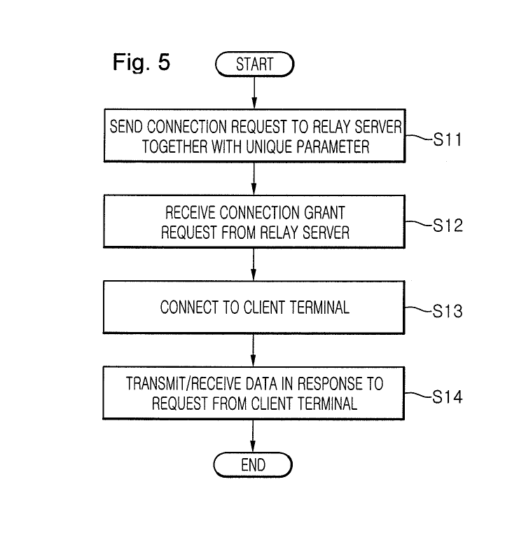

FIG. 5 is a flowchart illustrating a method for the communication terminal 20 pertaining to a private network to operate as a server according to an embodiment.

In operation S11, a connection request may be transmitted to the relay server 40 together with a unique parameter. In this case, the connection request may be transmitted through the gateway server 30.

In operation S12, a connection grant request is received from the relay server 40, a port W:d of the communication terminal 20 and a port Y:f of the relay server 40 may be connected to each other.

In operation S13, if the client terminal 50 is connected to the relay server 40 when the communication terminal 20 is connected to the relay server 40, the relay server 40 may connect the communication terminal 20 to the client terminal 50. Accordingly, the communication terminal 20 may be connected to the client terminal 50 through the gateway server 30 and the relay server 40.

In operation S14, the communication terminal 20 may operate as a server with respect to the client terminal 50, and may operate as a server in response to a request from the client terminal 50.

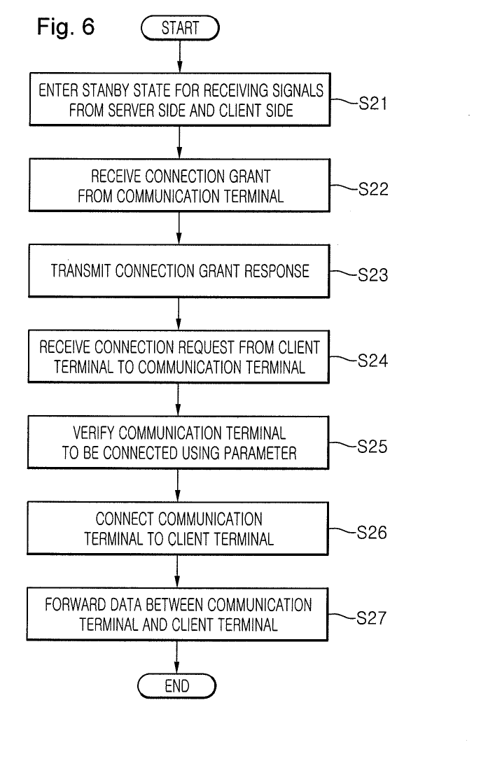

FIG. 6 is a flowchart illustrating a method for the communication terminal 20 pertaining to a private network to operate as a server in the relay server 40 according to an embodiment.

In operation S21, the relay server 40 may open two ports for receiving respective signals from a server and a client, and may be in a standby state.

In operation S22, a connection request may be received from the communication terminal 20 through a server-side port.

In operation S23, a connection grant response may be transmitted to the communication terminal 20 to be connected to the communication terminal 20. As described above, the port W:d of the communication 20 may be connected to the port Y:f of the relay server 40.

In operation S24, in a state of being connected to the communication terminal 20, the connection request of the communication terminal 20 may be received from the client terminal 50.

In operation S25, the communication terminal 20 having requested connection may be recognized by a unique parameter.

In operation S26, the communication terminal 20 and the client terminal 50 may be connected to each other. As shown in FIG. 4, the port W:d of the communication terminal 20 may be connected to the port Z:p of the client terminal 50. The communication terminal 20 may operate as a server with respect to the client terminal 50.

In operation S27, the relay server 40 may forward data exchanged between the communication terminal 20 and the client terminal 50.

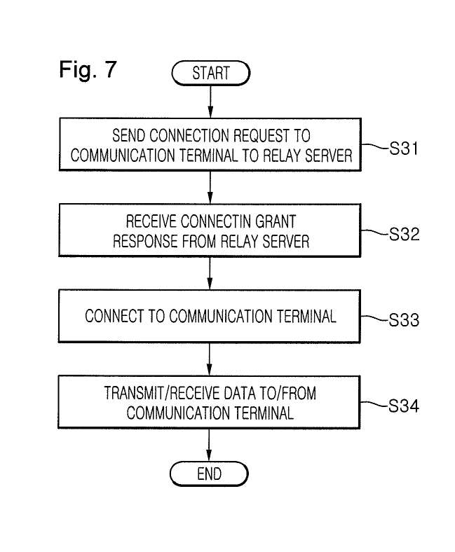

FIG. 7 is a flowchart illustrating a method for the communication terminal 20 pertaining to a private network to operate as a server in the client terminal 50 according to an embodiment.

In operation S31, a connection request to the communication terminal 20 may be transmitted to the relay server 40. In this case, unique information, i.e., a unique parameter for recognizing the communication terminal 20 may be together transmitted. The relay server 40 may be already connected to the communication terminal 20.

In operation S32, the communication terminal 20 may receive a connection grant response from the relay server 40, and may be connected to the relay server 40.

In operation S33, the communication terminal 20 is connected through the relay server 40. This status means that the communication terminal 20 can operate as a server with respect to the client terminal 50.

In operation S34, data is transmitted/received to/from the connected communication terminal 20. That is, a request is sent to the communication terminal 20, and thus data or processing result corresponding thereto may be received.

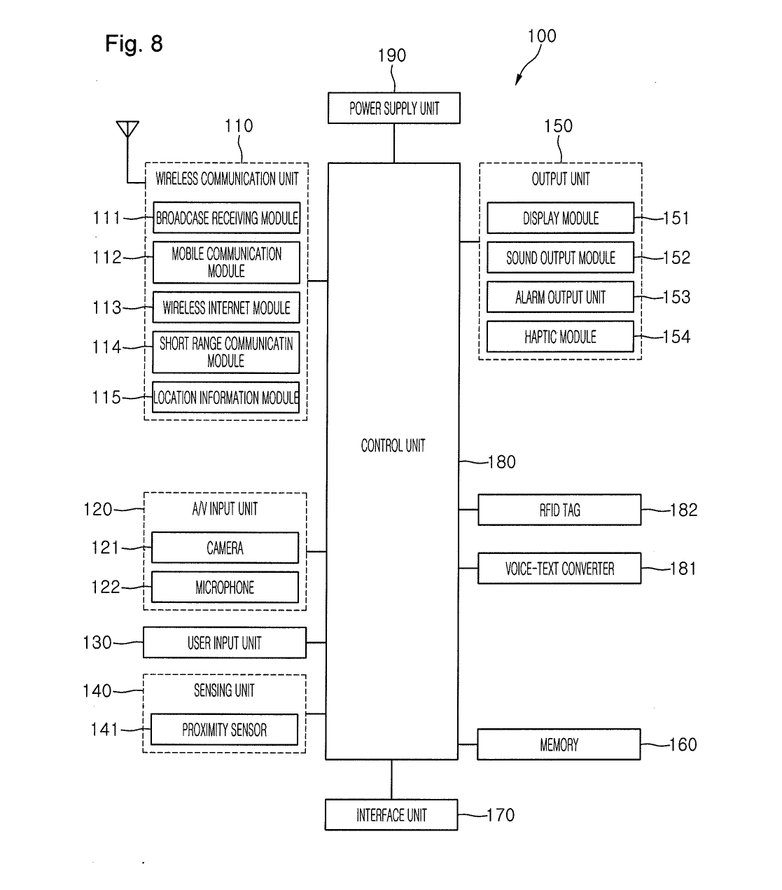

FIG. 8 is a block diagram illustrating a mobile terminal, more particularly, a mobile phone as an example of a communication terminal 20 according to an embodiment. As described below, a mobile phone 100 may be connected to the gateway server 30 through a mobile communication module 111, a wireless Internet module 113, or a shore range communication module 114.

The mobile phone 100 may include a communication unit 110, an A/V (Audio/Video) input unit 120, an input unit 130, a sensing unit 140, an output input 150, a memory 160, an interface unit 170, a control unit 180, and a power supply unit 190. However, the components shown in FIG. 8 are not essential components. Accordingly, a mobile terminal may be configured with the number of components greater or smaller than the number of components described in FIG. 8.

Hereinafter, the above components will be described one after another.

The communication unit 110 may include one or more modules that enable communication between the mobile phone 100 and a wireless communication system, the mobile phone 100 and a network with the mobile phone 100, and the mobile phone 100 and the gateway server 30.

For example, the communication unit 110 may include a broadcast receiving module 111, a mobile communication module 112, a wireless Internet module 113, a shore range communication module 114, and a location information module 115.

The broadcast receive module 111 may receive broadcast signals and/or information related to broadcasting from an external broadcast management server through broadcast channels.

The mobile communication module 112 may transmit/receive wireless signals to/from at least one of a base station, an external terminal, and a server. The wireless signals may include various types of data according to voice call signaling, image communication call signaling, or text/multimedia message communication.

Also, the mobile communication module 112 may be connected to the gateway server 30 according to an embodiment, and may send all data of the mobile phone 100 to the gateway server 30 according to the control of the control unit 180. As an example, the mobile communication module 112 may send all screen information displayed in a display module 151 to the gateway server 30, send audio information outputted from an audio output module 152 to the gateway server 30, and send a key signal inputted by the user input unit 130 and a touch signal inputted by the display module 151 of a touch screen type to the gateway server 30. When the mobile phone 100 is connected to the gateway server 30 through the mobile communication module 112, the gateway server 30 may be a server of a telecommunication service provider.

The wireless Internet module 113, which refers to a module for the wireless Internet connection, may be built in or out of the mobile phone 100. Examples of wireless Internet technologies may include Wireless LAN (WLAN) (Wi-Fi), Wireless broadband (Wibro), World Interoperability for Microwave Access (Wimax), and High Speed Downlink Packet Access (HSDPA).

Also, the wireless Internet module 113 may be connected to the gateway server 30 through Internet communication, and may send all data of the mobile phone 100 to the gateway server 30 according to the control of the control unit 180. As an example, the wireless Internet module 113 may send all screen information displayed in a display module 151 to the gateway server 30, send audio information outputted from the audio output module 152 to the gateway server 30, and send the key signal inputted by the user input unit 130 and the touch signal inputted by the display module 151 of the touch screen type to the gateway server 30.

When the mobile phone 100 communicates with the gateway server 30 through the wireless Internet module 113, the gateway server 30 may be a server of an Internet service provider.

The shore range communication module 114 refers to a module for shore range communication. Examples of short range communication technologies may include Bluetooth, Infrared Data Association (IrDA), Ultra Wideband (UWB), ZigBee, Wireless-Fidelity (Wi-Fi), and Remote Frame Buffer (RFB)

Also, the short range communication module 114 may be connected to the gateway server 30, and may send all data of the mobile phone 100 to the gateway server 30 according to the control of the control unit 180. As an example, the short range communication module 114 may send all screen information displayed in a display module 151 to the gateway server 30, send audio information outputted from the audio output module 152 to the gateway server 30, and send the key signal inputted by the user input unit 130 and the touch signal inputted by the display module 151 of the touch screen type to the gateway server 30.

The location information module 115 is a module for acquiring the location of the mobile phone 100. As a representative example, there is a Global Position System (GPS) module.

Referring to FIG. 8, The A/V input unit 120, which is for audio signal or video signal input, may include a camera 121 and a microphone 122.

The camera 121 may process image frames such as still images or videos that are acquired by an image sensor in a video telecommunication mode or a photographing mode. The processed image frames may be displayed in the display module 151.

Two or more cameras 121 may be provided according to the usage environment. The image frame processing in the camera 121 may be sent to the gateway server 30 through the communication unit 110.

The microphone 122 may receive external sound signals through a microphone in a call mode, a recording mode, or a voice recognition mode to process the external sound signals into electrical voice data.

In the call mode, the processed voice data may be converted into a form that can be transmitted to a mobile communication base station through the mobile communication module 112. The microphone 122 may be configured with various noise removal algorithms for removing noises generated in the course of receiving the external sound signals.

The user input unit 130 may generate input data for user's operation control of the mobile phone 100. The user input unit 130 may include a key pad dome switch, touch pad (static pressure/static electricity), a jog wheel, and a jog switch.

In this case, a backlight unit may be provided under the user input unit 130.

The sensing unit 140 may detect the open/close status of the mobile terminal 100, the location of the mobile terminal 100, the user's contact with the mobile terminal 100, the direction of the mobile terminal 100, the acceleration/deceleration of the movement of the mobile terminal 100, and the like, to generate sensing signals for controlling the operation of the mobile terminal 100.

The output unit 150 is configured to output a video signal, an audio signal, or a touch signal, and may include a display module 151, an audio output module 152, an alarm output module 153, a haptic module 154.

The display 151 may include at least one of a Liquid Crystal Display (LCD), a Thin Film Transistor-Liquid Crystal Display (TFT-LCD), an Organic Light-Emitting Diode (OLED), a flexible display, and a three-dimensional (3D) display.

Two or more of such display modules 151 may be provided according to the configuration type of the mobile phone 100. For example, a plurality of display modules may be individually or integrally disposed on one surface, or may be separately disposed on different surfaces.

On the other hand, the display module 151 and a sensor (hereinafter, referred to as a ‘touch sensor’) for sensing a touch operation have a mutual layer structure (hereinafter, referred to as a ‘touch screen’), the display module 151 may be used as an input device as well as an output device. For example, the touch sensor may include a touch film, a touch sheet, and a touch pad.

The touch sensor may be configured to convert a change of pressure applied to a specific spot or electrostatic capacity generated in a specific spot of the display module 151 into an electrical input signal. The touch sensor may be configured to detect the pressure of the touch as well as the location and area of the touched spot.

A proximity sensor 141 refers to a sensor used to detect presence or absence of an object approaching a certain detection surface or a nearby object using a force of the electromagnetic field or an infrared ray without a physical contact. The proximity sensor may have a longer life than the touch sensor, and may have more various uses than the touch sensor.

Examples of the proximity sensor 141 may include a transmission-type photoelectric sensor, a direct reflection-type photoelectric sensor, a mirror reflection-type photo sensor, an RF oscillation-type proximity sensor, an electrostatic capacitance-type proximity sensor, a magnetic proximity sensor, and an infrared proximity sensor.

The audio output module 152 may output audio data received from the communication unit 110 or stored in the memory 160 in a call signal reception mode, a call mode, a recording mode, a voice recognition mode, and a broadcast reception mode.

Also, the audio output module 152 may output audio signals (e.g., a call signal reception sound, a message reception sound, etc.) related to functions performed by the mobile terminal 100. The audio output module 152 may include a receiver, a speaker, a buzzer, and the like.

The alarm output module 153 may output signal to inform of the occurrence of an event of the mobile terminal 100. Examples of events generated in the mobile phone 100 may include call signal reception, message reception, key signal input, touch input.

The haptic module 154 may generate various tactile effects that can be sensed by a user. Examples of the tactile effects generate by the haptic module 154 may include vibration. The intensity and pattern of the vibration generated by the haptic module 154 may be controlled. For example, different vibrations may be synthetically or sequentially outputted.

The memory 160 may store programs used for the operations of the control unit 180, or may temporarily store data (e.g., phonebooks, messages, still images, videos, etc.) that are to be inputted/outputted. Also, the memory 160 may store data about various patterns of vibrations and sounds outputted when a touch is applied to the touch screen.

Also, the mobile terminal 100 may be provided with an OS program for controlling the operations of the components of the mobile phone 100 and a plurality of applications for executing content information in the mobile phone 100.

Examples of the applications may include a word processor, an image viewer, a video player, an audio player, an Internet explorer. The OS program and application described above may be run and executed according to the control of the control unit 180.

On the other hand, the above OS programs and applications may be stored in the memory 160 as a software type described above, or may be provided in a “module” type.

The interface unit 170 may serve as a passage to all external devices connected to the mobile phone 100.

The above interface unit 170 may include a wire/wireless headset port, an external charge port, a wire/wireless data port, a memory card port, a connection port for a device provided with an identity module, an audio I/O port, a video I/O port, an earphone port, and a Universal Serial Bus (USB).

That is, the interface unit 170 may be wire-connected to the gateway server 30 through a data cable to send all data of the mobile phone 100 to the gateway server 30. As an example, the interface unit 170 may send all screen information displayed in the display module 151 to the gateway server 30, send audio information outputted from the audio output module 152 to the gateway server 30, and send key signals inputted from the user input unit 130 and touch signals inputted from the display module 151 of the touch screen type to the gateway server 30.

The control unit 180 may typically control overall operations of the mobile phone 100. For example, the control unit 180 performs controlling and processing associated with voice calls, data communications, video calls. The controlling operation of the control unit 180 will be described in detail below.

A voice-text converter 181 may convert voice signal inputted from the microphone 122 into text signals, or may convert call voice signal received from the communication unit 110 into text signals.

Also, the voice-text converter 181 may convert text signal inputted from the user input unit 130 or the display unit 151 of the touch screen type into voice signals, or may convert message contents received from the communication unit 110 into voice signals.

The voice-text converter 181 as described above may be formed with a Text To Speech (TTS) module.

Also, an RFID tag 182 may be provided to record device information of the mobile phone 100 used for communication connection with the gateway server 30.

On the other hand, the power supply unit 190 may be applied with external power and internal power according to the control of the control unit 180, and then may supply power necessary for operations of the respective components.

Various embodiments described herein may be implemented in a recording media that are readable by computer or other similar devices using, for example, software, hardware, or any combination thereof.

For hardware implementation, the embodiments described herein may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and other electronic units designed to perform the functions. In some cases, such embodiments may be implemented by the control unit 180.

For software implementation, the embodiments about procedures or functions may be implemented together with separate software modules that enable at least one function or operation. Software codes can be implemented by a software application written in an appropriate programming language. The software codes may be stored in the memory 160 and may be executed by the controller 180.

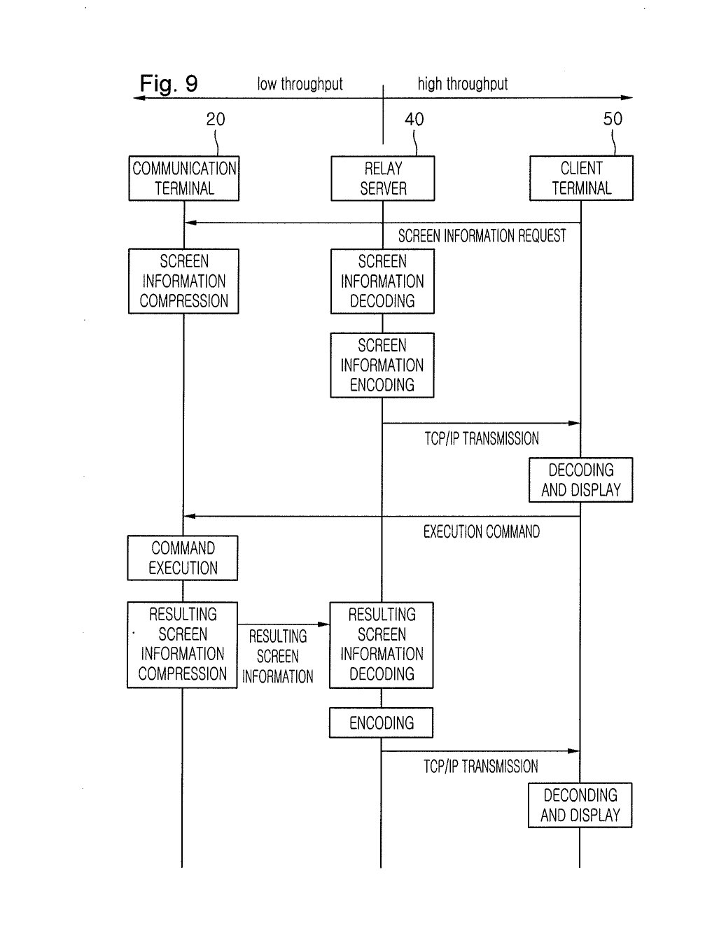

FIG. 9 is a view illustrating a method for a client terminal 50 to remotely control a communication terminal 20 by connecting to the communication terminal 20 according to another embodiment.

Referring to FIG. 9, a communication terminal 20 and a relay server 40 may be connected to each other through a low rate (i.e., low throughput) communication method. The relay server 40 and a client terminal 50 may be connected to each other through a high-rate (high throughout) communication method.

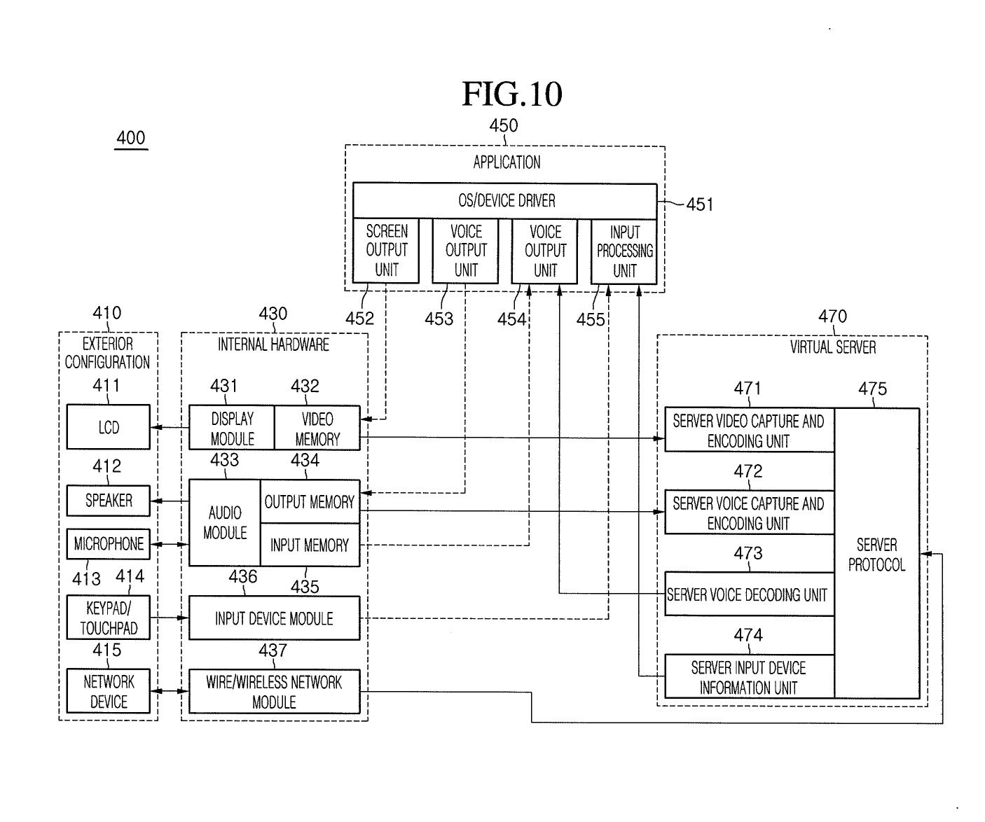

The low throughput communication between the communication terminal 20 and the relay server 40 may be performed by a method described with reference to FIGS. 10 to 16. The communication between the relay server 40 and the client terminal 50 may be performed through, for example, TCP/IP.

In FIG. 9, the communication terminal may have a certified IP without belonging to a private network. In this case, the gateway server 30 performing the NAT function of FIGS. 3 and 4 may be unnecessary.

In this embodiment, the communication terminal 20 may compress its own user interface, e.g., screen information of the display to deliver to the relay server 40 through a low rate communication network. The relay server 40 may decode the compressed screen information, and encode again the decoded screen information to data for high rate communication and then deliver the data to the client terminal 50. The client terminal 50 may decode and display the screen information. A user of the client terminal 50 may input command for controlling the communication terminal 20 using the screen information. The command may be again delivered to the communication terminal 20. Thereafter, the communication terminal 20 may perform the command, and then send the result to the client terminal 50 through the relay server 40. For instance, the same screen information (e.g., contents, images, pop-ups, windows, etc.) displayed or displayable on the display unit of the communication terminal 20 can be sent to the client terminal 50 through the relay server 40, and then displayed on the display unit of the client terminal 50. The screen information can be a screen phone information window which may identify various information related to calls, such as call menus for making calls, receiving calls, transferring calls, managing calls, reviewing call histories, etc. A user at the client terminal 50 can review and manage the displayed screen information at the display unit of the client terminal 50, and enter a selection/input to the display unit of the client terminal 50 in view of the displayed screen information. This selection/input can be sent back by the client terminal 50 to the communication terminal 20 via the relay server, and the communication terminal 20 executes the selection/input and sends the result of the execution to the client terminal 50 through the relay server for display, reproduction, updating, etc.

In FIG. 9, the communication terminal 20 and the gateway server 30 may be wirelessly connected to each other, for example, through a mobile communication network or a local are network such as WiFi. When connected by the mobile communication network, the communication terminal 20 may be a mobile phone and the relay server 40 may be a mobile communication server provider. When connected by the local area network, the communication terminal 20 may be a desktop computer, a laptop computer, or a mobile terminal equipped with WiFi, and the relay server 40 may be a router that can perform an IP address conversion function, a proxy server, or a server of an Internet server provider.

Referring to FIG. 9, the client terminal 50 may request screen information from the communication terminal through the relay server 40. In response to the request, the communication terminal 20 may transmit the screen information displayed on the communication terminal 20 to the relay server 40 through a method for transmitting screen information described below. In this case, the relay server 40 may encode the received screen information into a format that can be sent using a high rate communication method, e.g., Internet communication network, i.e., TCP/IP protocol. In this case, image compression techniques such as jpg and gif may be used. The encoded screen information may be sent to the client terminal 50.

The client terminal 50 may decode and display the received screen information. A user may input commands using the displayed screen information. The client terminal 50 may send the commands to the communication terminal 20 through the relay server in turn. The communication terminal 20 may process the received command, and send the resulting screen information according to the processed result to the relay server 40 through a low rate communication method. The relay server 40 may encode the resulting screen information using a high rate communication method, i.e., Internet protocol to transmit the encoded screen information to the client terminal 50. The client terminal 50 may decode and display the received resulting screen information.

According to the above configuration, a user of the client terminal 50 may remotely and rapidly control the communication terminal 20 such as a mobile phone connected by a low throughput communication method. Particularly, when the communication terminal 20 is a mobile terminal such as a mobile phone, the communication terminal 20 can be operated even at a low power. Accordingly, the battery consumption of the mobile terminal can be reduced, and upload data can also be reduced.

Hereinafter, a process for compressing and decompressing screen information in a communication terminal and a gateway server according to an embodiment will be described in detain with reference to FIGS. 10 to 16. Hereinafter, embodiments may be applied to a process for the communication terminal 20 of FIG. 1 to transmit screen information to the client terminal 50 through the gateway server 30 or the relay server 40.

FIG. 10 is a block diagram illustrating a first terminal for compressing image information displayed on a screen in an operation control system according to a first embodiment.

Hereinafter, the configuration of a first terminal 400 of FIG. 10 may include components identical to or different from those of the communication terminal 20 of FIG. 2 or the mobile phone 100 of FIG. 8.

The first terminal 400 of FIG. 10 and the first terminal 100 of FIG. 8 may be the same device, and may perform the same operations as each other.

Hereinafter, a process for compressing screen information using the first terminal 400 shown in FIG. 10 will be described in detail in the first embodiment below.

Referring to FIG. 10, the first terminal for implementing a operation control system may include an exterior configuration 410, an internal hardware 430, an application 450, a virtual server 470, and a control unit (identical to the control unit 180 of FIG. 2 or 8, hereinafter, reference numeral 180).

The exterior configuration 410 of the first terminal 400 may include an LCD 411, a speaker 412, a microphone 413, a keypad/touch pad 414, and a network device 415.

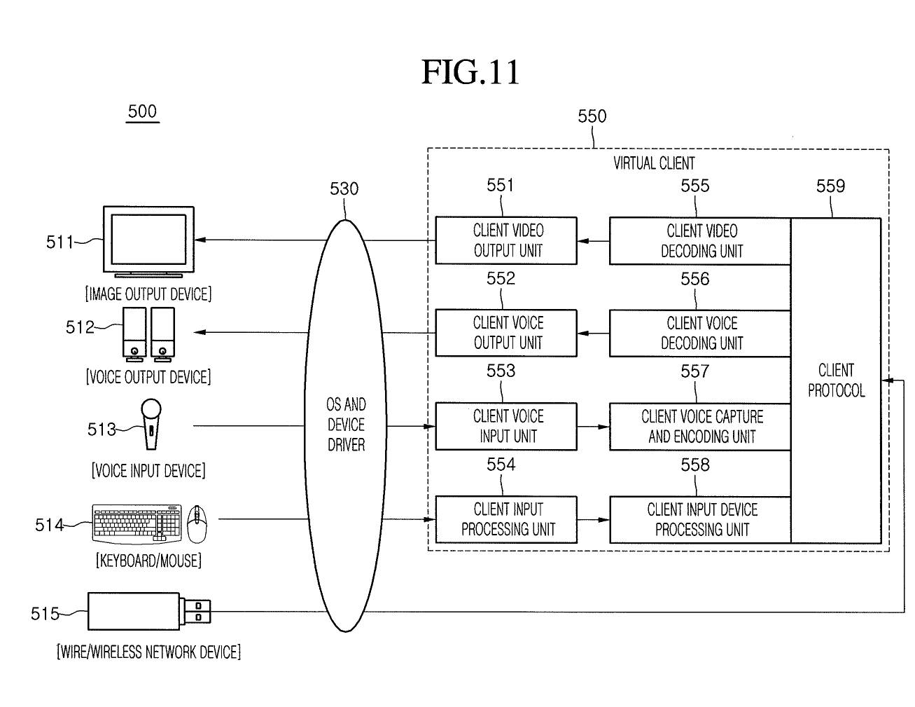

The internal hardware 430 may include a display module 431, a video memory 432, an audio module 433, an audio output memory 434, an audio input memory 435, an input device module 436, and a wire/wireless network module 437. Here, the video memory 432 may store and output image information on the screen of the first terminal 400. The wire/wireless network module 437 may be connected to the external network device 415 to transmit compressed and encoded image information to a second terminal (500 of FIG. 11). The second terminal 500 may be a gateway server 30 of FIG. 1.

The application 450 may be implemented in software, and may include an OS/device driver 451, an image output unit 452, a voice output unit 453, a voice input unit 454, and an input processing unit 455.

The virtual server 470 may be implemented in software, and may include a server video capture and encoding unit 471, a server voice capture and encoding unit 472, a server voice decoding unit 473, a server input device information unit 474, and a server protocol 475.

The server video capture and encoding unit 471 of the virtual server 470 may receive the image information on the screen of the first terminal 400 from video memory 432, and may extract low frequency and intermediate frequency from the inputted image information.

The server video capture and encoding unit 471 may compare the low frequency and intermediate frequency of the current image information with the low frequency and intermediate frequency of the previous image information to determine the degree of the change of the current screen information, and determine the current image information as ‘whole change’, ‘partial change’, or ‘no change’ according to the degree of the change.

If the server video capture and encoding unit 471 determines the current image information as ‘whole change’, the low frequency and intermediate frequency of the current image information may be quantized, respectively.

If the server video capture and encoding unit 471 determines the current image information as ‘partial change’, the low frequency and intermediate frequency of the current image information may be quantized, respectively, and then information representing a difference between the low frequency and intermediate frequency of the current image information and the low frequency and intermediate frequency of the previous image information may be generated.

If the server video capture and encoding unit 471 determines the current image information as ‘no change’, the high frequency of the current image information may be extracted. Thereafter, the server video capture and encoding unit 171 may perform entropy encoding on the compressed image information.

If the server video capture and encoding unit 471 determines the current image information as ‘no change’, the intermediate frequency of the current image information may be quantized, and then difference information between the quantized intermediate frequency and the intermediate frequency in ‘whole change’ or ‘partial change’ may be generated. Here, the quantization of the intermediate frequency in ‘no change’ may have a higher resolution than the quantization of the intermediate in ‘whole change’ or ‘partial change’.

In this case, if the degree of the change of the current image information is determined, the server video capture and encoding unit 471 may count the number of pixels having a change therebetween greater than a certain critical value, or calculate the ratio thereof.

If the server video capture and encoding unit 471 determines the current screen information as ‘no change’, a process for sampling a certain number of pixels may be further performed on the current image information.

In this case, the server video capture and encoding unit 471 may compare the sampled pixels with sampled pixels in the previous image information. If the number of pixels having a change between corresponding pixels greater than a certain critical value, or the ratio thereof, the current image information is again determined as ‘partial change’, and then the process corresponding to ‘partial change’ may be performed.

The control unit 180 may control the image output unit 452 of the application 450 and the server video capture and encoding unit 471 of the virtual server 470 to compress, encode, and output the image information of the first terminal 400. In this case, respective identifiers corresponding to ‘whole change’, ‘partial change’, and ‘no change’ are added to the compressed image information to be outputted. For example, the identifier may include 0, 1, and 2.

In the configuration of the first terminal 400 for implementing the operation control system, the exterior configuration 410 may be connected to the respective corresponding components of the internal hardware 430. The respective components of the internal hardware 430 may be controlled by the application 450, and the virtual server 470 may be connected to the application 450 and the internal hardware 430, and thus data or commands may be transmitted or received.

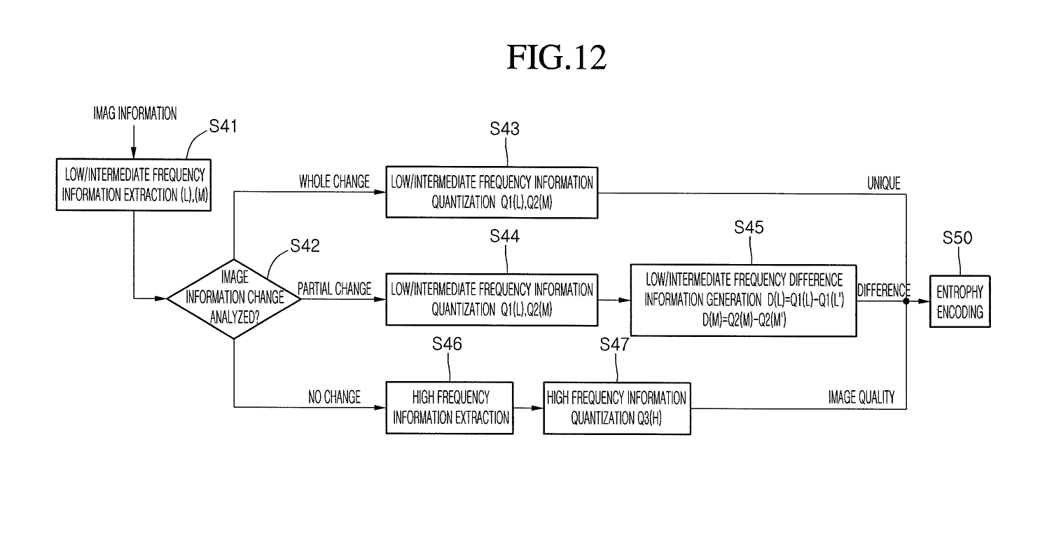

FIG. 11 is a block diagram illustrating a second terminal of a PC type for decompressing compressed image information in an operation control system according to a first embodiment. The second terminal 500 of FIG. 11 may be a client terminal 50 of FIG. 1. However, in FIG. 1, screen information may be received through the gateway server 30 and the relay server 50, and the function of decompressing information compressed by the compression method described by referring to FIGS. 12 to 14 may be performed in the gateway server 30.

As shown in FIG. 11, a virtual client 550 may include a client protocol 559, a client video decoding unit 555, a client voice decoding unit 556, a client voice capture and encoding unit 557, and a client input device information unit 558, which are components intactly displaying image information received from a first terminal 400 through a wire/wireless network device 515. The respective components may be connected to OS and hardware of the second terminal 500 via a client image output unit 551, a client voice output unit 552, a client voice input unit 553, and a client input processing unit 554.

The virtual client 550 may be connected to an image output device 511, a voice output device 512, a voice input device 513, and a keyboard/mouse 514 through an OS/device driver 530.

A client video decoding unit 555 of FIG. 11 may decode and decompress the compressed and encoded image information in the server video capture and encoding unit 471 of FIG. 10. The decompression of the compressed image information may be the inverse of the process of compressing the image information.

The client video decoding unit 555 may perform entropy decoding on the received compressed image information, and determine whether the image information is unique image information, difference image information, or image quality recovery image information using an identifier included in the compressed image information.

If the client video decoding unit 555 determines the received image information as unique image information using the identifier, the low frequency and the intermediate frequency of the unique image information may be dequantized, and then the dequantized low frequency and intermediate frequency may be synthesized. The synthesized image may not include high frequency information, and thus interpolation may be performed to output smooth recovery image information.

If the client video decoding unit 555 determines the received image information as difference image information using the identifier, quantized low frequency and intermediate frequency information may be generated by adding the difference information between the low frequency and the intermediate frequency and the previous image information, and then the low frequency and the intermediate frequency information may be dequantized. The dequantized low frequency and intermediate frequency information may be synthesized. In case of the difference image information, since high frequency information may not be included the synthesized image, it is preferable to perform interpolation.

Also, if the client vide decoding unit 555 determines the received image information as image quality recovery image information using the identifier, the high frequency information may be dequantized, and then the dequantized high frequency information and the already recovered low frequency and intermediate frequency information may be synthesized. Thus, since the synthesized image may include all of the low frequency, the intermediate frequency, and the high frequency information in the process of recovering the image quality recovery image information, it is unnecessary to perform interpolation.

The image information decompressed by the client video decoding unit 555 may be sent to video output unit 551, and then the image information may be displayed on the image output device 511 of the second terminal 500.

The client video decoding unit 555 may recover high-resolution intermediate frequency information from high-resolution intermediate frequency difference information generated in the compression process.

In this case, the recovery of the high-resolution intermediate frequency information may be expressed as Equation (1).

Q4(M)=Q4(Q2⁻¹(Q2(M)))+X(M) (1)

where Q2−1(Q2(M)) means using a processing result of unique image information or difference image information.

As shown in FIGS. 10 and 11, the operation control system according to the embodiments may be implemented by a combination of hardware and software, particularly, by the virtual server 470 mounted in the first terminal 400 and the virtual client 550 mounted in the second terminal 500.

The virtual server 470 and the virtual client 550 may be wired or wireless connected by the network device 415 of the first terminal 400 and the wire/wireless network device 515 of the second terminal 500. The virtual server 470 may compress image information on the screen of the first terminal 400 to send the compressed image information to the virtual client 550 of the second terminal by this connection. The virtual client 550 may deliver the image information received from the first terminal to the image output device 511 in real-time.

FIG. 12 illustrates exemplary image compression of the first terminal 400 that is performed in the server video capture and encoding unit 471 of the virtual server 470.

As shown in FIG. 12, the image compression of the first terminal may include extracting low frequency and intermediate information, analyzing a change of image information by comparing previous image information and current image information using the extracted low frequency and intermediate information to determine the degree of the change of the current image information, generating unique image information, difference image information, or image quality recovery image information by varying a quantization subject and presence or absence of difference information generation according to the degree of the change of the current image information, and encoding the generated image information, respectively. Hereinafter, image compression of the first terminal 400 according to an embodiment will be described in detail with reference to FIG. 12.

In operation S41, low frequency and intermediate frequency information may be extracted from image information. The images of the first terminal may be inputted as successive image information (e.g., frames).

The inputted image information may be first analyzed and extracted into low frequency L and intermediate frequency M information. When the image information is analyzed into the low frequency and intermediate frequency information, a wavelet transform may be used. However, Haar wavelet may be used for a small amount of operation. In operation S41, high frequency H information may not be extracted from corresponding image information. This is because there is a high possibility that a user of the first terminal does not perform a text reading when images are extremely changed by animation/scrolling.

In operation S41, the low frequency and intermediate frequency information may have a relatively low spatial resolution, resulting in reduction of the unique image information. Also, only the low frequency and intermediate frequency information may be extracted from the image information, resulting in high compression ratio. In operation S41, only the integer addition/subtraction operation may be performed, or only the integer addition/subtraction and logic operations may be performed.

In operation S42, the degree of the change of the current image information is analyzed compared to the previous image information. The low frequency and intermediate frequency information of the previous image information may be compared with those of the current image information, respectively.

First, the lower frequency information may be compared. A critical value may be determined to evaluate the degree of a change between pixels corresponding to the low frequency information of the previous image information and the low frequency information of the current image information. The critical value means an enough degree to recognize that there is a change. The critical value may be variously selected from about 10%, 20%, 30%, and 50%. Thereafter, the number of pixels having a change therebetween greater than the critical value may be counted.

Next, the intermediate frequency information may be compared. It may be analyzed whether the degree of the change between pixels corresponding to the intermediate frequency information of the previous image information and the intermediate frequency information of the current image information deviate from the critical value.

Here, the critical value regarding the change of the low frequency information may be applied to that regarding the change of the intermediate frequency information. The critical value may be varied in consideration of the characteristics of the intermediate frequency information.

The number of pixels deviating from the critical value regarding the low frequency information and the number of pixels deviating from the critical value regarding the intermediate frequency information may be summed up.

In this case, the current image information may be determined as ‘whole change’, ‘intermediate change’, and ‘no change’ according to the ratio of the number of the summed pixels to the number of the whole pixels.

For example, if the percentage of the number of the pixels that are recognizably changed is more than about 50%, the current image information may be determined to have been considerably changed compared to the previous image information, and the degree of the change of the current image information may be determined as “whole change”. If the percentage of the number of the pixels that are recognizably changed ranges from about 5% to about 50%, the current image information may be determined to have been partially changed in the screen, and the degree of the change of the current image information may be determined as “partial change”.

If the percentage of the number of the pixels is less than about 5%, the current image information may be determined to have not been changed compared to the previous image information, and the degree of the change of the current image information may be determined as ‘no change’.

Here, although it has been described that determination criterion of the percentage is set to about 50% and about 5%, the determination criterion may be variously selected from about 70% and about 10%, about 50% and about 0%, and the like. Alternatively, the number of pixels may be used as a determination criterion instead of the percentage of the number of the pixels.

In operation S43, when the current image information has been determined as ‘whole change’, the low frequency and intermediate frequency information may be quantized to generate unique image information. Here, the unique image information means image information including original image information intactly, but strictly speaking, it means image information excluding high frequency information from the original image information.

In this case, since the low frequency information includes most important information, the quantization of the low frequency information may have the highest resolution. The quantization of the intermediate frequency information may have a lower resolution than the low frequency information.

In operations S44 and S45, when the current image information has been determined as ‘partial change’, the low frequency and intermediate frequency information of the current image information may be quantized, respectively, and then the quantization of the low frequency and intermediate frequency information of the current image information may be compared with the quantization of the low frequency and intermediate frequency information of the previous image information to generate difference image information.

Here, the difference image information refers to image information generated in regard to the difference information between the current image information and the previous image information in the low frequency information and the intermediate frequency information.

As shown in operation S45, the low frequency and intermediate frequency difference information may be expressed as D(L)=Q1(L)−Q1(L′) and D(M)=Q2(M)−Q2(M′). Here, D(L) is difference information about the low frequency information, and D(M) is difference information about the intermediate frequency information. Q1(L) and Q2(M) are results of quantizing the low frequency and intermediate frequency information of the current image information, respectively. Q1(L′) and Q2(M′) are results of quantizing the low frequency and intermediate frequency information of the previous image information, respectively.

In operation S45, the quantization resolution of the low frequency and intermediate information may be maintained equal to the quantization resolution of the low frequency and intermediate frequency information in case of being determined as ‘whole change’.

Only a part that is changed may remain as a meaningful value by acquiring the difference information in operations S44 and S45, and thus an amount of data (not changed) may be compressed in an encoding process.

In operations S46 and S47, when the current image information has been determined as ‘no change’, high frequency information may be additionally extracted from the current image information, and then the extracted high frequency information may be quantized (Q3(H)) to generate image quality recovery image information.

The image quality recovery image information may contain only additional information for the image quality because the low frequency and intermediate frequency information have been delivered in the previous operation. The image quality may be so improved by the image quality recovery image information as to recognize a tiny letter.

The reason for choosing a method of transmitting the high frequency information only when there is no change in an image is that a user of the first terminal will not feel inconvenience even if the user performs a text reading when the image change is stopped. That is, this is a result of reflecting the habit of the user in using the first terminal.

Here, the high frequency information has a high spatial resolution, but approaches to 0. Accordingly, an amount of compression may occur in the entropy encoding process. Also, since the high frequency information is insensitive to eyes, quantization of the lowest resolution is performed.

In operation S50, entropy encoding may be performed on the unique image information, the difference image information, and the image quality recovery image information that have been generated in operations S43 to S47. Identifier such as 0, 1, and 2 may be added to the respective image information.

The identifiers may be included in each of the unique image information, the difference image information, and the image quality recovery image information to be transmitted to the virtual client 550 of the second terminal. When the compressed unique image information, difference image information, and image quality recovery image information are decompressed in the virtual client 550 of the second terminal, the types of the transmitted image information may be discriminated by the identifier.

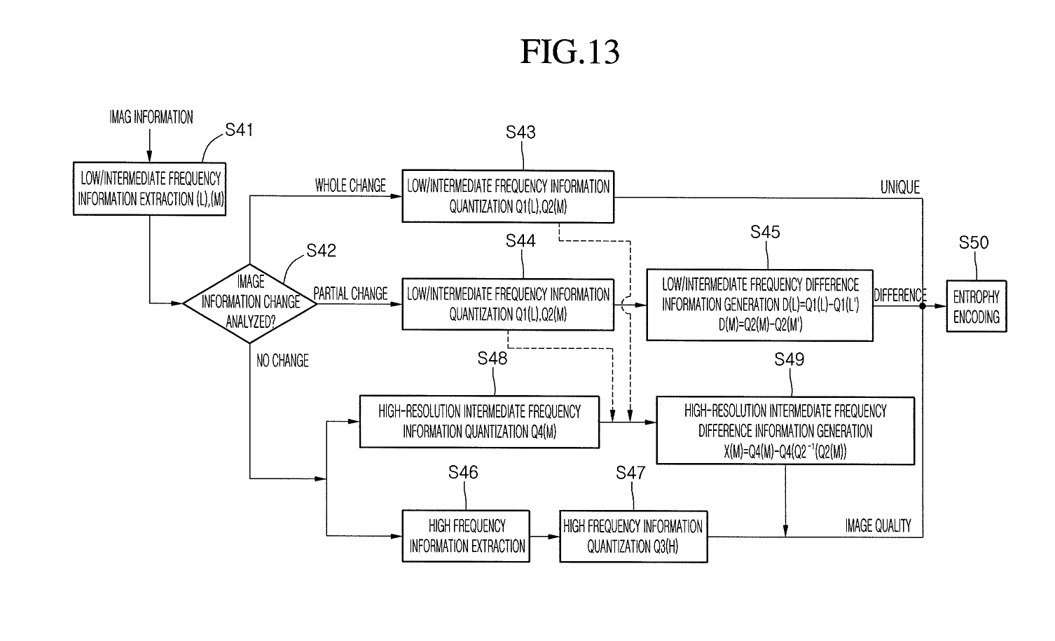

FIG. 13 is a view illustrating image compression of the first terminal according to another embodiment.

As shown in FIG. 13, another exemplary image compression of the first terminal performed in the server video capture and encoding unit 471 of the virtual server 470 may further include performing operations S48 and S49 when the current image information is determined to be ‘no change’ in FIG. 12.

In operation S48, the intermediate frequency information may be quantized (Q4(M)) in a higher resolution than the quantization resolution of the intermediate frequency information in ‘whole change’ or ‘partial change’. That is, the image quality of the intermediate frequency information may be further improved.

The quantization result of operation S48 may be sent to an encoding process after difference information between the quantization of the intermediate frequency in ‘whole change’ or ‘partial change’ and the quantization of the intermediate frequency in ‘no change’ is generated.

As seen from Equation, X(M)=Q4(M)−Q4(Q2−1(Q2(M))) of operation S49, the high-resolution intermediate frequency difference information may be generated by a difference between the result of quantizing the intermediate frequency information in a high resolution and the result of dequantizing the quantization of the intermediate frequency information of ‘whole change’ or ‘partial change’ and again quantizing the dequantized result in a high resolution.

In operation S49, the quantized result of operation S48 may be further compressed.

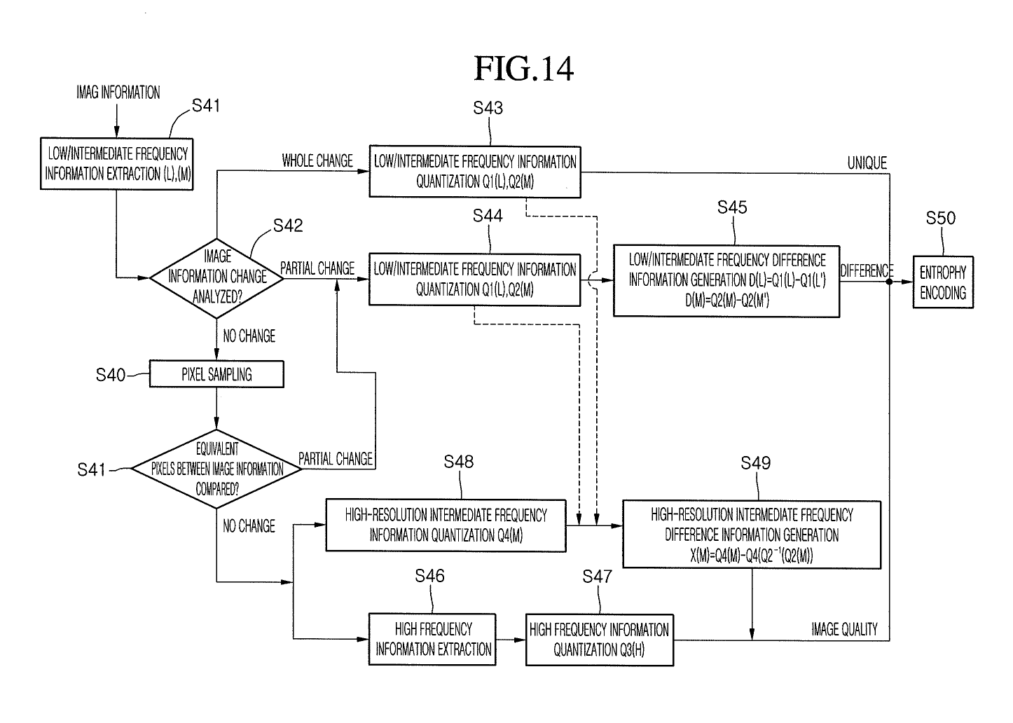

FIG. 14 is a view illustrating image compression of the first terminal according to still another embodiment. As shown in FIG. 14, still another embodiment of the image compression of the first terminal performed in the server video capture and encoding unit 471 of the virtual server 470 may further include performing operations S40 and S41 when the current image information is determined to be ‘no change’ in FIGS. 12 and 13.

In FIG. 14, it may be again determined whether the current image information can be determined as ‘partial change’ when the current image information has been determined to be ‘no change’.

In operation S40, a certain number of pixels corresponding to each other may be sampled from the pixels of the current image information and the previous image information. Here, the number of the sampled pixels may be determined in consideration of the operation ability of the first terminal. For example, 9, 12, 15, 16, or 20 pixels may be sampled from the respective image information.

In operation S41, the pixels sampled from the current image information may be compared with the pixels sampled from the previous image information. In this case, if the number of the pixels sampled from the current image information and the pixels sampled from the previous image information above a critical value is greater than a certain number or ratio, the current image information may be again determined as ‘partial change’.

Here, the certain number, which is a comparison criterion, may be one. The certain ratio may be variously selected from about 3%, 5%, and 10%. In this operation, if the current image information is determined as ‘partial change’, operation S44 may be performed. If the current image information is determined as ‘no change’, operation S46 or S48 may be performed.

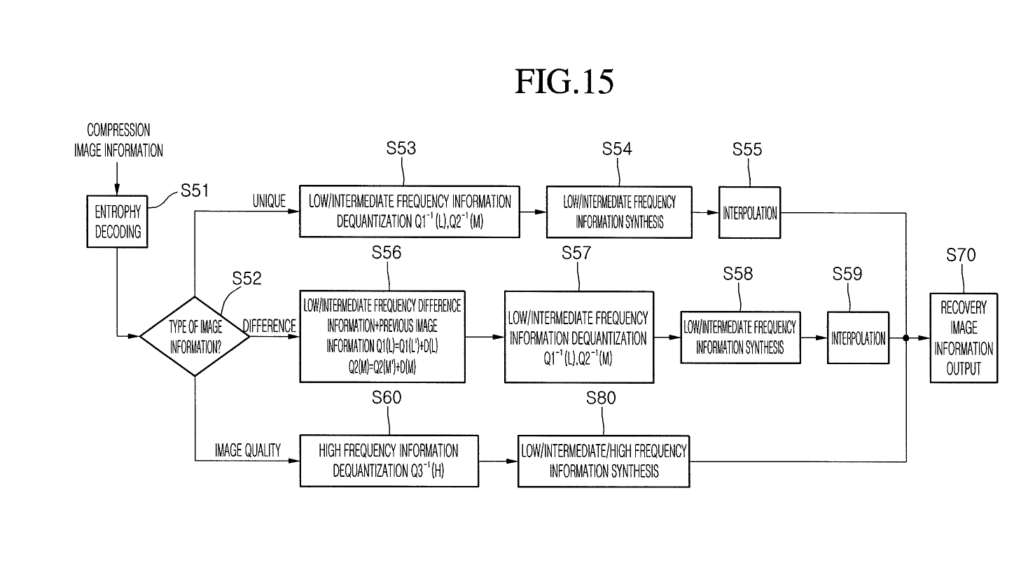

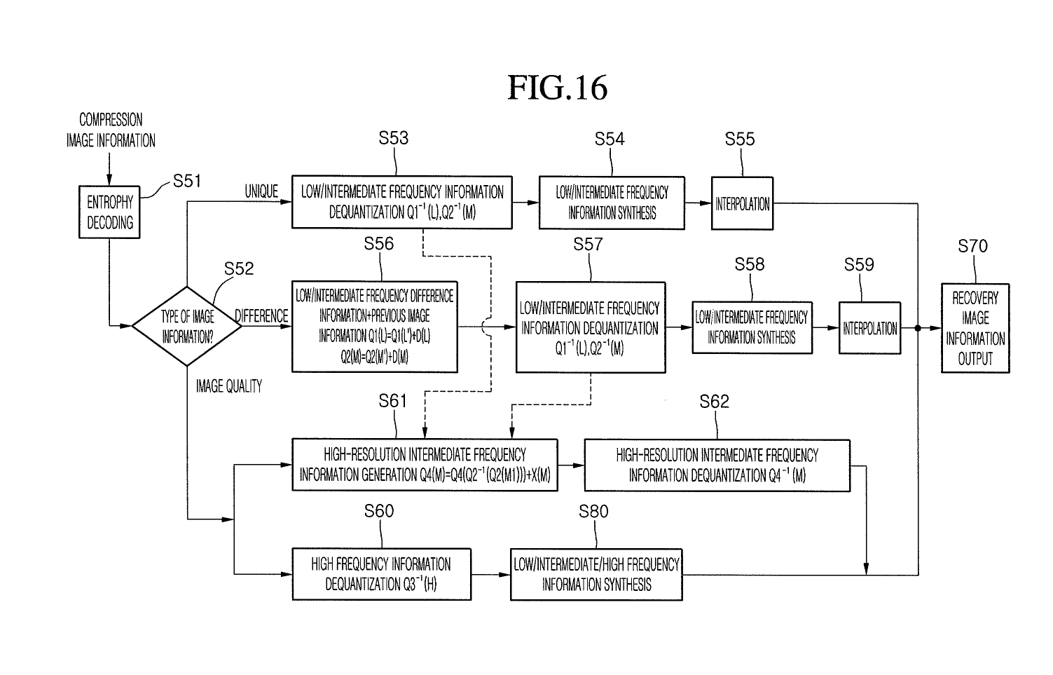

Hereinafter, a process of decompressing a compressed image received from a first terminal in a second terminal will be described in detail with reference to FIGS. 15 and 16.

Embodiments of FIGS. 15 and 16 may be the inverse of the process of FIGS. 12 and 13. It will be apparent that those skilled in the art who understand the compression process can readily understand the decompression process of FIGS. 12 and 13 without detailed description.

FIG. 15 is a view illustrating a process of decompressing the compressed image of FIG. 12 according to an embodiment. That is, the embodiment of FIG. 15 may be performed in the client video decoding unit 555 of the virtual client 550 of the second terminal.

Referring to FIG. 15, entropy decoding may be performed on compression data in operation S51. Thereafter, in operation S52, it is determined whether image information received from the first terminal is unique image information, difference image information or image quality recovery image information, using identifiers included in the respective image information.

If the received image information is determined to be unique image information in operation S52, quantized low frequency and intermediate frequency information of the unique image information may be dequantized in operation S53.

In operation S54, the dequantized low frequency and intermediate frequency information may be synthesized. Since the synthesized image may not include high frequency information, interpolation may be performed in operation S55. Consequently, more smooth recovery image information can be outputted.

If the received image information is determined to be difference image information in operation S52, a difference of the low frequency and intermediate frequency information may be added to the previous image information to generate quantized low frequency and intermediate frequency information in operation S56.

Then, the low frequency and intermediate frequency information may be dequantized in operation S57. Thereafter, in operation S58, the dequantized low frequency and intermediate frequency information may be synthesized. Since the synthesized image may not include high frequency information even in the difference image information, interpolation may be performed in operation S59.

If the received image information is determined to be image quality recovery image information in operation S52, quantization high frequency information may be dequantized in operation S60. Thereafter, in operation S80, the dequantized high frequency information and the already-recovered low frequency and intermediate frequency information may be synthesized. Thus, in the recovery process of the image quality recovery image information, the synthesized image include all of low frequency, intermediate frequency, and high frequency information, interpolation needs not to be performed.

The recovery image information processed in each case may be send to the video output unit 551 in operation S70.

FIG. 16 is a view illustrating a process of decompressing the compressed image of FIG. 13 according to another embodiment.

As shown in FIG. 16, a process of decompressing the compressed image of FIG. 13 may further include recovering high-resolution intermediate frequency information from the high-resolution intermediate frequency difference information generated in the compression process of FIG. 13.

The quantization result of the high-resolution intermediate frequency may be recovered by the equation of operation S61, Q4(M)=Q4(Q2−1(Q2(M)))+X(M).

Here, Q2−1(Q2(M)) may use the processing result of the unique image information or the difference image information. Thereafter, the high-resolution intermediate frequency quantization result may be dequantized in operation S62, and thus the high-resolution intermediate frequency information may be recovered.

In the first embodiment described above, the image compression and decompression processes of the first and second terminals have been described in detail.

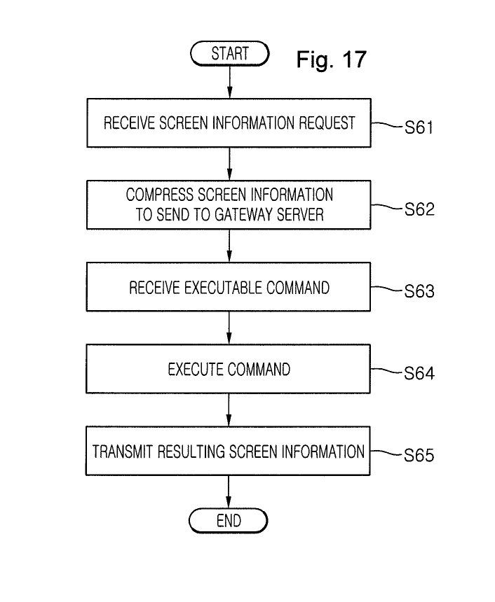

FIG. 17 is a flowchart illustrating a process performed by a communication terminal 20 during the process of transmitting screen information from the communication terminal to a client terminal 50 according to an embodiment. Hereinafter, the communication terminal 20 may be connected to the client terminal 50 by the method described with reference to FIGS. 3 and 4 or by other methods. The communication terminal 20 may belong to a private network, and may operate as a server with respect to the client terminal 50.

In operation S61, a screen information request may be received from the client terminal 50.

In operation S62, screen information may be compressed to be sent to the gateway server 30 according to the method described with reference to FIGS. 12 to 14. The gateway server 30 may encode the screen information into a format that can be transmitted through Internet protocol, and then send the encoded screen information to the relay server 40. The relay server 40 may forward the screen information to the client terminal 50.

In operation S63, an executable command may be received from the client terminal 50.

In operation S64, the received executable command is executed. In operation S65, screen information resulting from the execution may be transmitted to the gateway server 30.

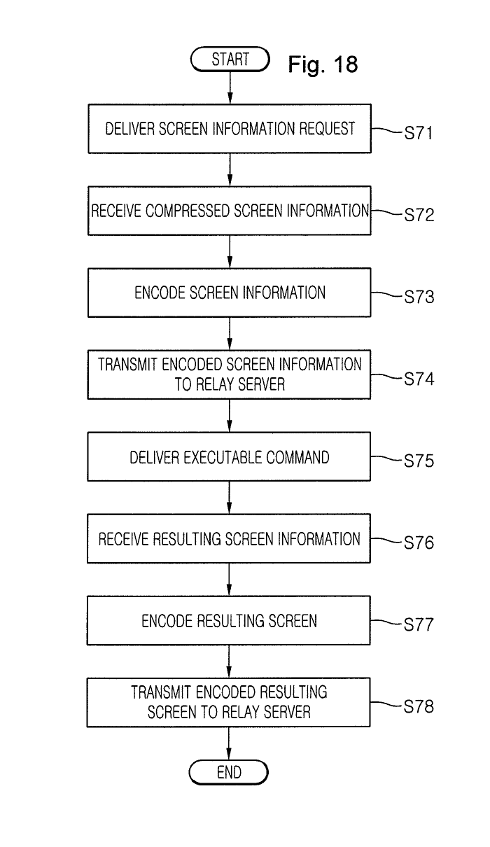

FIG. 18 is a flowchart illustrating a process performed by a gateway server 30 during a process of transmitting screen information from a communication terminal 20 to a client terminal 50 according to an embodiment.

In operation S71, a screen information request from the client terminal 50 may be transmitted to the communication terminal 20.

In operation S72, compressed screen information may be received from the communication terminal 20.

In operation S73, the received screen information is decompressed, and then encoded into a format that can be transmitted through Internet. In this case, an image compression coding method such as jpg or gif may be used. The decompression may be performed by the method described with reference to FIGS. 15 and 16.

In operation S74, the encoded screen information may be transmitted to the relay server 40.

In operation S75, an executable command may be received from the client terminal 50, and then may be transmitted to the communication terminal 20.

In operation S76, screen information resulting from the execution may be received from the communication terminal 20. In operation S77, the screen information resulting from the execution may be encoded. In operation S78, the encoded screen information may be transmitted to the client terminal 50.

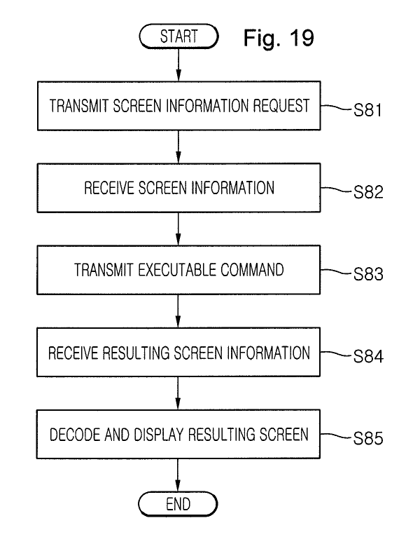

FIG. 19 is a flowchart illustrating a process performed by a client terminal 50 during a process of transmitting screen information from a communication terminal 20 to the client terminal 50 according to an embodiment.

In operation S81, a screen information request may be transmitted to the communication terminal 20.

In operation S82, the screen information may be received through the relay server 40.

In operation S83, a menu may be displayed based on the screen information, and an executable command selected by a user may be transmitted to the communication terminal 20.

In operation S84, screen information resulting from the command execution may be received from the communication terminal 20.

In operation S85, the received screen information may be decoded and displayed.

### Embodiment 3

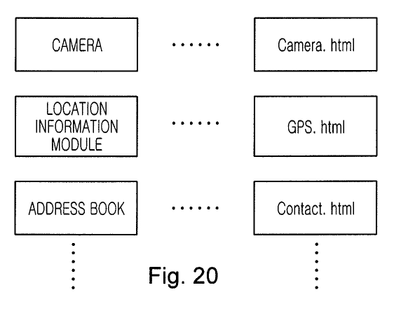

FIG. 20 is a view illustrating a method for remotely controlling a communication terminal 20 through a client terminal 50 by a user according to an embodiment.

The communication terminal 20 may perform various functions. Software performing the respective functions may be called by Application programming Interface (API). That is, when a user inputs commands through a mouse, a keyboard, a button, or a touch screen in the communication terminal 20, API may call and execute the functions to be performed. Command codes corresponding to respective APIs may be transmitted to the client terminal 50. If a user of the client terminal 50 selects and transmits a command code, the communication terminal 20 may execute API corresponding to the command code. Accordingly, a user of the client terminal 50 may execute the functions of the communication terminal 20 remotely. The command codes, i.e., APIs may be configured with HTML files.

Referring to FIG. 20, if the communication terminal is assumed to be a mobile phone, a command code for calling a camera function of the mobile phone may be configured with camera.html, a command code for calling a location information module function of the mobile phone may be configured with GPS.html, and a command code for calling an address search function of the mobile phone may be configured with contact.html. APIs for calling other functions may be configured with HTML files. Here, the camera function may be a function performed by the camera 121 of FIG. 8, the location information module function may be a function performed by the location information module 115, and the address search function displays addresses stored in the memory 160 may be a function performed by the control unit 180.

The communication terminal 20 may incorporate HTML files including a list of APIs for performing respective functions into one HTML file, and may send the HTML file to the client terminal 50. The client terminal 50 may display a remote control menu of the communication terminal 20 using the received HTML file. A user may control the functions of the communication terminal 20 using the remote control menu.

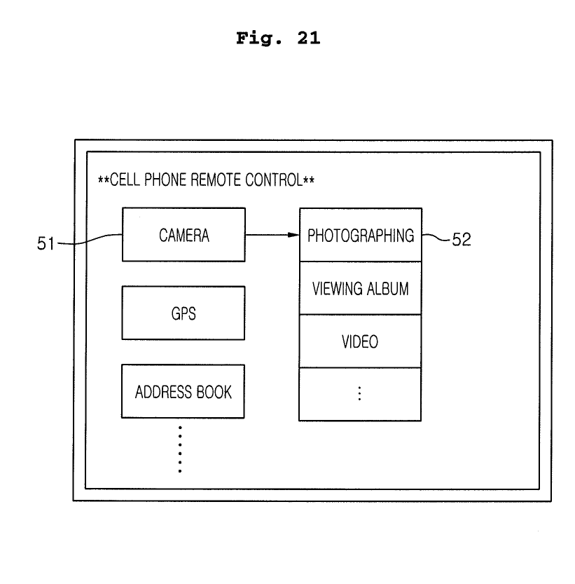

FIG. 21 is a view illustrating a menu screen displayed on a client terminal 50 to perform remote control according to an embodiment.

As shown in FIG. 21, menus for each function may be displayed on the menu screen. The respective menus may be generated using the HTML file of FIG. 20. If a camera menu 51 is selected, the submenus 52 thereof may be displayed. If one of the submenus is selected, a command string of the HTML file corresponding to the selected submenu may be transmitted to the communication terminal 20. The communication terminal 20 may convert the command string into an executable API code, and may call and execute a corresponding function. The menu configuration for remote control may be variously modified according to embodiments.

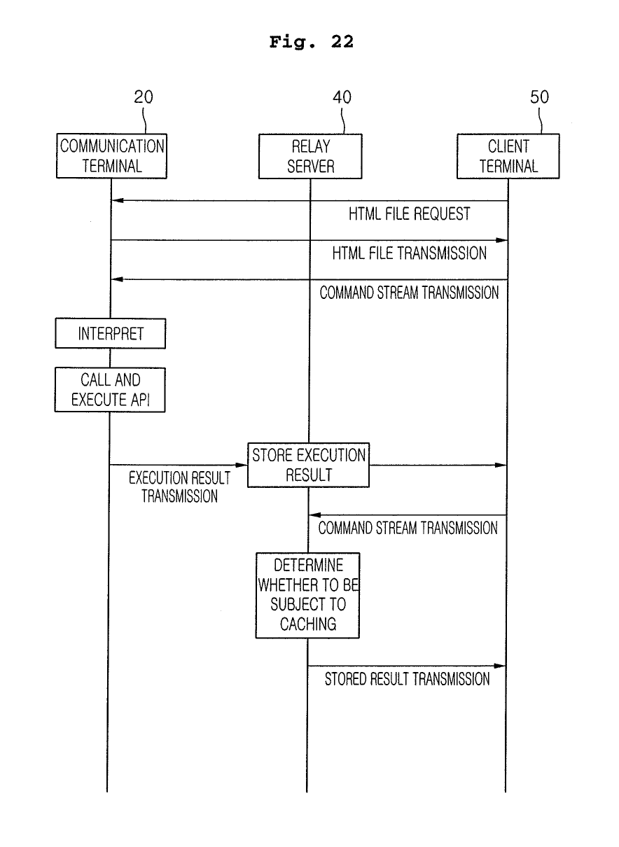

FIG. 22 is a view illustrating a method for a client terminal 50 to remotely control a communication terminal 20 using an HTML file according to an embodiment.

The client terminal 50 and the communication terminal 20 may communicate with each other through the relay server 40. The relay server 40 may be a server performing an NAT function, a proxy server, a server of an Internet service provider, or a server of a mobile communication service provider when the communication terminal 20 is a mobile phone.

The client terminal 50 may request an HTML file including command codes for executing API of the communication terminal 20. In response to the request, the communication terminal 20 may send the HTML file including command codes for executing API to the client terminal 50. The client terminal 50 may configure a menu with the received HTML file, and display the menu. If a user selects an executable command from the displayed menu, a command string corresponding to the executable command may be sent to the communication terminal 20.

The communication terminal 20 may convert the received command string into an API execution code, that is, may interpret the received command string, and may execute API to call corresponding software. Then, the communication terminal 20 may send a result executed by software to the client terminal 50.

Here, the communication terminal 20 may operate as a server with respect to the client terminal 50, and may be connected by the method described with reference to FIGS. 3 and 4, or the method described with reference to FIG. 9.

According to an embodiment, the relay server 40 may perform a caching function with respect to a command from the client terminal 50.

For example, the relay server 40 may send the command to the communication terminal 20 and receive an execution result, and then store the execution result. However, if the same command is received form the client terminal within a certain time, the relay server 40 may not deliver the stored execution result to the communication terminal 20, but may deliver the stored execution result to the client terminal 50.

The caching processing may be performed only on a command that needs not to be again executed. For example, a command such as viewing of photo album stored in the communication terminal 20 needs not to be executed because the same data is provided even though the commanded is executed within a certain time. However, the caching function can not be performed on a command such as photographing.

According to an embodiment, when the communication terminal 20 transmits a HTML file including command strings to the client terminal 50, commands that require the caching processing and commands that do not require the caching processing may be discriminated from each other using comments. For example, if a special symbol, for example, “@@” is displayed in the symbol <!— —> that is widely used as a comment of a HTML document, the relay server 40 or the client terminal 50 may determine a corresponding command string to be subject to caching, without affecting the original purpose of the HTML document for usage. For example, a symbol <!—@@—> may follow a command code that is subject to caching.

Also, the valid time of caching may be included in the comment. The relay server 40 may not deliver a command to the communication terminal 20, but may transmit the stored execution result to the client terminal 50 if the same command is received within a valid time, for example, about 10 seconds after the first command is received.

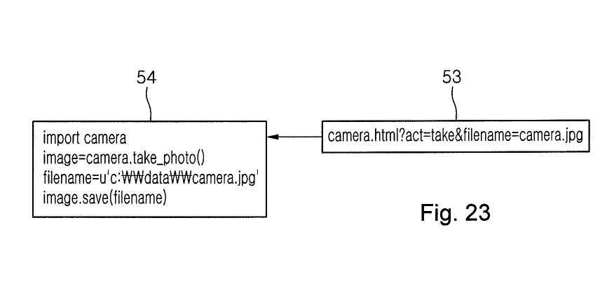

FIG. 23 is a view illustrating a relation between an execution code transmitted from a client terminal 50 and an API command performed by a communication terminal 20 according to an embodiment.

A command code 53 transmitted to the communication terminal 20 by the client terminal 50 may be converted into an API code 54 executable in the communication terminal 20. Since such a conversion is well known in the web programming field, detailed description thereof will be omitted herein.

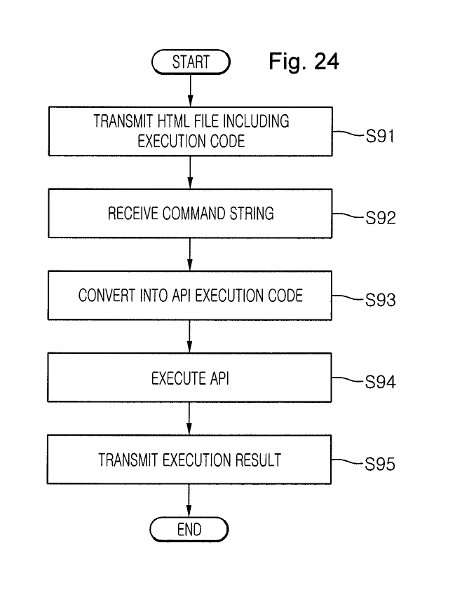

FIG. 24 is a flowchart illustrating a process performed in a communication terminal 20 during a process of controlling a communication terminal 20 in a client terminal 50 according to an embodiment.

In operation S91, an HTML file including an executable code for API that can perform respective functions of the communication terminal 20 may be sent to the client terminal 50.

In operation S92, a code string for one API may be received from the client terminal 50.

In operation S93, the received code string may be converted into API.

In operation S94, the converted API may be executed.

In operation S94, the result or data of the API execution may be transmitted to the client terminal 50. In this case, the result or data of the API execution may be transmitted by the method described in FIGS. 12 to 14.

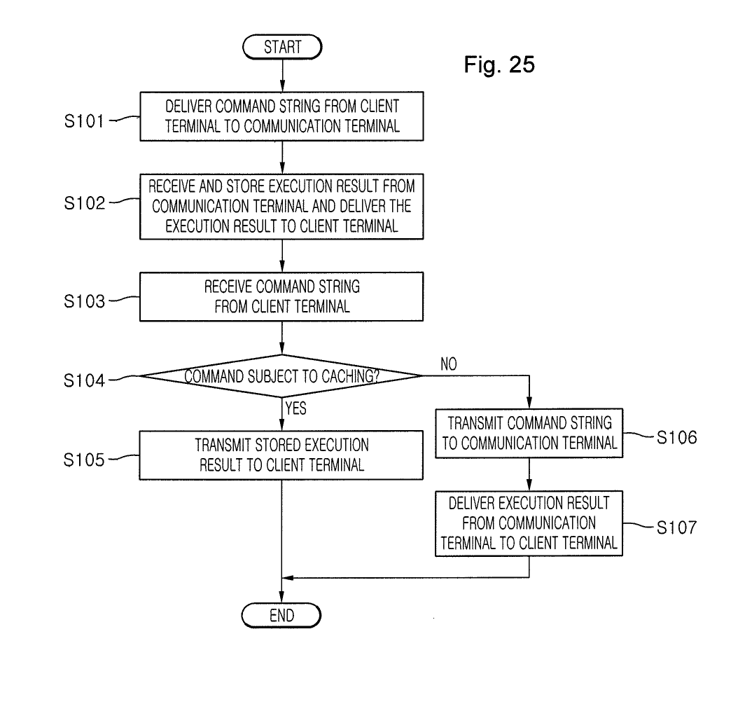

FIG. 25 is a flowchart illustrating a process performed in a relay server 40 during a process of controlling a communication terminal 20 in a client terminal 50 according to an embodiment.

In operation S101, a command string may be delivered from a client terminal from a communication terminal. The command string may be a command code for executing API included in an HTML file delivered from the communication terminal to the client terminal. In operation S102, software called by API may be executed to perform functions. The execution result may be received from the communication terminal, and then may be delivered to the client terminal.

In operation S103, a command string may be received from the client terminal.

In operation S104, it may be determined whether the received command string is subject to caching. Then, it may be determined whether the received command string corresponds to the caching condition, that is, whether the command string is a previously processed command string or the valid time has passed by.

If the command string is subject to caching, in operation S105, the execution result stored in the relay server 40 may be sent to the client terminal.

If the command string is not subject to caching or does not satisfy the caching condition, in operation S106, the command string may be sent to the communication terminal, and in operation S107, the execution result may be received from the communication terminal to be sent to the client terminal.

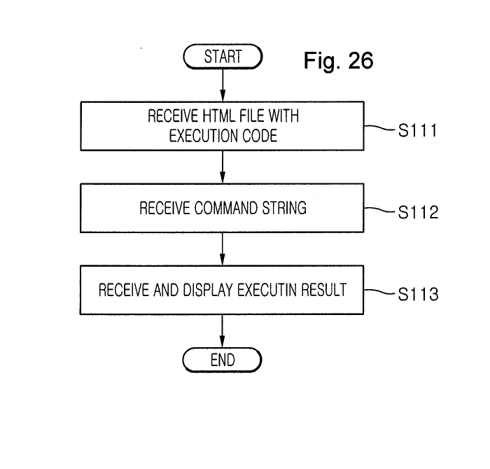

FIG. 26 is a flowchart illustrating a process performed in a client terminal 50 during a process of remotely controlling a communication terminal 20 through a client terminal 50.

In operation S111, an HTML file including executable codes for API of the communication terminal 20 may be received from the communication terminal 20.

In operation S112, a menu may be configured with the HTML file, and then may be displayed. A code string selected from the displayed menu by a user may be sent to the communication terminal 20.

In operation S113, the command execution result may be received from the communication terminal 20, and then may be displayed.

### Embodiment 4

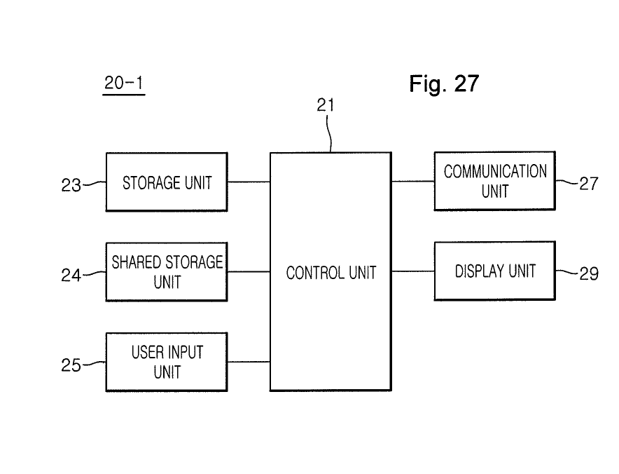

FIG. 27 is a view illustrating a configuration of a communication terminal 20-1 having a shared storage unit 24 shared with a client terminal 50 according to an embodiment.

Referring to FIG. 27, the configuration of the communication terminal 20-1 may be similar to that of the communication terminal 20 of FIG. 2, and may be different from the communication terminal 20 in that the communication terminal 20-1 includes a shared storage unit 24. The communication terminal 20-1 may further include the shared storage 24 that can access the client terminal 50 for reading and writing. According to an embodiment, the shared storage 24 may be configured with a storage unit 23 and a separate storage medium, or may allow a portion of the storage unit 23 to be shared.

The control unit 21 of the communication terminal 20-1 may monitor whether there is a change such as recoding or deleting in the shared storage unit 24. If a new executable command is detected during the monitoring, the detected executable command may be read and executed. Accordingly, the client terminal 50 may remotely control the communication terminal 20-1 by recording the command to be executed by the communication terminal 20-1 in the shared storage unit 24.

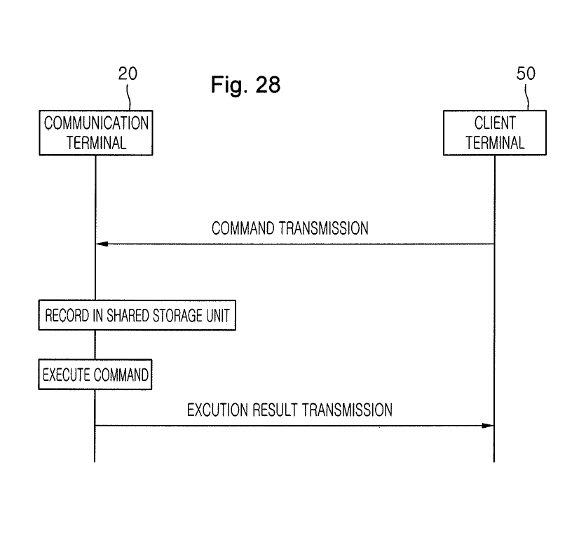

FIG. 28 is a view illustrating a method for remotely controlling a communication terminal 20-1 by a client terminal 50 using a shared storage unit 24 of the communication terminal 20-1 according to an embodiment.

The client terminal 50 may access the communication terminal 20-1 to record an executable command in a shared storage unit. During monitoring of the shared storage unit, the control unit 21 of the communication terminal 20-1 may detect whether the executable command is recorded. If the executable command is detected, the control unit 21 may execute the detected executable command, and then may send the execution result to the client terminal 50.

In the above embodiment, the executable command recorded in the shared storage unit may be a command string described in FIGS. 20 to 26. The execution of the detected executable command by the control unit 21 may be to convert the detected command code into an API execution code, and then call and execute corresponding software by the execution of API.

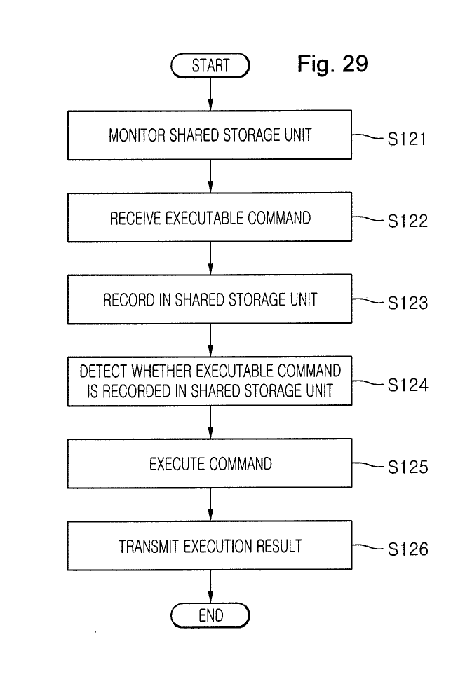

FIG. 29 is a flowchart illustrating a method performed by a communication terminal 20 during a process of remotely controlling a communication terminal 20 by a client terminal 50 according to an embodiment.

In operation S121, it may be monitored whether update information exist in the client terminal 50 and the shared storage unit.

In operation S122, if an executable command is received from the client terminal 50, the execution storage unit may be recorded in the shared storage unit in operation S123.

In operation S124, it may be detected that the executable command has been recorded in the shared storage unit.

In operation S125, the command recorded in the shared storage unit may be executed, and in operation S116, a result of the execution may be sent to the client terminal 50.

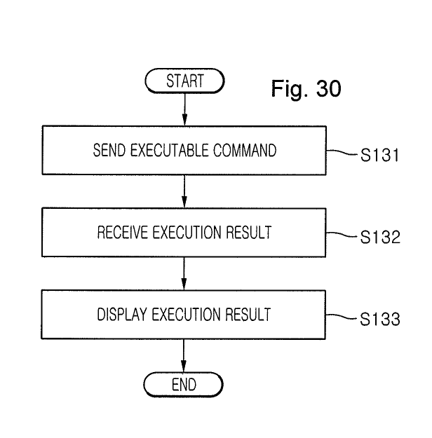

FIG. 30 is a flowchart illustrating a process performed by a client terminal 50 during a process of remotely controlling a communication terminal 20 by the client terminal 50 according to an embodiment.

In operation S131, an executable command may be sent to the communication terminal 20. The executable command may be recorded in the shared storage unit of the communication terminal 20. The executable command recorded in the shared storage unit may be read from the communication terminal 20, and be executed. In operation S132, a result of the execution may be received. In operation S133, the result of the execution may be displayed.

The methods according to the above embodiment may be implemented in a program executable in a general-purpose processor such as a computer. The program may be stored in a communication terminal, a gateway server, a relay server, or a client terminal. Examples of computer readable recording media may include ROMs, RAMs, CD-ROMs, magnetic tapes, floppy disks, and optical data storage devices. Alternatively, the program may be implemented in a form of a carrier wave (e.g., transmission through Internet).

The computer readable recording media may be distributed in a computer network system, and codes that a computer can read in a distribution method may be stored. The functional programs, codes, and code segments may be readily inferred by programmers skilled in the art.

Besides the above embodiment, embodiments of inventive concept may be variously modified. These modified embodiments may be included in the scope of the inventive concept.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A remotely controllable communication terminal comprising:
a user input unit configured to receive a user input;
a storage unit configured to store software to be called by Application Programming Interfaces (APIs) corresponding respectively to a plurality of functions;
a communication unit; and
a control unit cooperating with the user input unit, the storage unit and the communication unit, and configured to:
send, through the communication unit, a file including a list of the APIs to a client terminal,
receive a selection of an API from the list of the APIs from the client terminal,
execute a function corresponding to the selected API using the stored software, and
send a result of the execution of the function to the client terminal.

2. The remotely controllable communication terminal according to claim 1, wherein the file including the list of the APIs is a Hyper Text Markup Language (HTML) file.

3. The remotely controllable communication terminal according to claim 1, wherein the communication terminal is connected to the client terminal through a relay server having a certified Internet Protocol (IP).

4. The remotely controllable communication terminal according to claim 3, wherein the communication terminal and the client terminal transmit at least one shared parameter to the relay server, and
wherein the relay server discriminates between the communication terminal and the client terminal using the shared parameter.

5. The remotely controllable communication terminal according to claim 3, wherein the communication terminal is a mobile phone, and the relay server is a server of a mobile communication service provider,
the communication terminal being connected to relay server using a mobile communication protocol, and the relay sever being connected to the client terminal using an Internet protocol.

6. The remotely controllable communication terminal according to claim 1, wherein the file including the list of the APIs comprises information indicating whether a caching is applied to the respective APIs and valid time information of the caching, and
wherein the relay server perform a caching on the selected API received from the client terminal.

7. The remotely controllable communication terminal according to claim 1, further comprising:
a shared storage unit accessible by the client terminal for reading data from the shared storage unit and/or writing data to the shared storage unit by the client terminal,
wherein the selected API received from the client terminal is recorded in the shared storage unit, and the control unit monitors the shared storage unit to detect a newly recorded API code and to execute the detected API code.

8. A method for controlling a remotely controllable communication terminal, the method comprising:
sending, by the communication terminal to a client terminal, a file including a list of execution codes for respectively executing Application Programming Interfaces (APIs);
receiving, by the communication terminal, a selection of an executed code from the list from the client terminal;
converting, by the communication terminal, the received selected execution code into an executable API;
performing, by the communication terminal, a function corresponding to the executable API; and
sending, by the communication terminal, a result of the performed function to the client terminal.

9. The method according to claim 8, wherein the file including the list of execution codes is a Hyper Text Markup Language (HTML) file.

10. The method according to claim 8, wherein the communication terminal is connected to the client terminal through a relay server having a certified IP.

11. A communication terminal operating as a server, comprising:
a user input unit configured to receive a user input;
a storage unit configured to store software for executing operations of the communication terminal; a shared storage unit shared with a client terminal; and
a control unit cooperating with the user input unit, the storage unit, and the shared storage unit, and configured to:
receive a request from the client terminal,
record the received request in the shared storage unit,
monitor the shared storage unit and determine whether the received request is recorded in the shared storage unit,
read the request recorded in the shared storage unit based on the determining results,
execute the read request, and
send a result of the execution of the request to the client terminal.

12. The communication terminal according to claim 11, wherein the request comprises an Application Programming Interfaces (API) code, and
if the API code is determined to be recorded in the shared storage unit, the control unit executes the recorded API to perform a corresponding function.

13. The communication terminal according to claim 11, wherein the storage unit stores software to be called by APIs corresponding to respective functions.

14. The communication terminal according to claim 11, the control unit further configured to:
send a file including information on Application Programming Interfaces (APIs) to the client terminal,
wherein the request received from the client terminal is a selection of an API using the file.

15. The communication terminal according to claim 14, wherein the information on the APIs includes a list of APIs or a list of execution codes for executing respectively APIs.

16. The communication terminal according to claim 11, wherein the communication terminal is connected to the client terminal through a relay server having a certified IP.

17. The communication terminal according to claim 16, wherein the communication terminal is a mobile phone, and the relay server is a server of a mobile communication service provider,
the communication terminal being connected to the relay server using a mobile communication protocol, and the relay sever being connected to the client terminal using an Internet protocol.

18. A method for controlling a communication terminal operating as a server, the communication terminal including a shared storage unit shared with a client terminal, the method comprising:
receiving, by the communication terminal, a request from the client terminal;
recording the received request in the shared storage unit of the communication terminal;
monitoring the shared storage unit and determining whether the received request is recorded in the shared storage unit;
reading the request recorded in the shared storage unit based on the determining results;
executing, by the communication terminal, the read request; and
sending, by the communication terminal, a result of the execution of the request to the client terminal.

19. The method according to claim 18, further comprising:
sending, by the communication terminal, a file including information on Application Programming Interfaces (APIs) to the client terminal,
wherein the request received from the client terminal is a selection of an API using the file.

20. The method according to claim 19, wherein the information on the APIs includes a list of APIs or a list of execution codes for executing respectively APIs.
